(19) United States
(12) Patent Application Publication
(10) Pub. No.: US 2016/0154170 A1
(43) Pub. Date: Jun. 2, 2016

(54) ULTRA-THIN DISPLAY USING THIN FLEXIBLE LED LIGHT SHEET

(71) Applicant: Nthdegree Technologies Worldwide Inc., Tempe, AZ (US)

(72) Inventors: Travis Thompson, Chandler, AZ (US); Bradley S. Oraw, Chandler, AZ (US); Alexander Ray, Tempe, AZ (US); Andrew Dennis, Gilbert, AZ (US); Mark D. Lowenthal, Vancouver, WA (US); Sarah Behm Thompson, Chandler, AZ (US); William J. Ray, Fountain Hills, AZ (US); Richard A. Blanchard, Los Altos, CA (US); Neil O. Shotton, Tempe, AZ (US); Tammie Woolgar, Phoenix, AZ (US); Joseph Nathan, Bloomfield Hills, MI (US); Jeffrey Baldridge, Chandler, AZ (US); David Hardinger, Chandler, AZ (US)

(21) Appl. No.: 15/014,335

(22) Filed: Feb. 3, 2016

Related U.S. Application Data
(63) Continuation-in-part of application No. 14/303,410, filed on Jun. 12, 2014.
(60) Provisional application No. 62/115,508, filed on Feb. 12, 2015.

(51) Int. Cl. F21V 8/00; F21K 99/00

(52) U.S. Cl. CPC G02B 6/0073; G02B 6/0051; G02B 6/0055; G02B 6/005; G02B 6/0068; F21K 9/56; F21K 9/52; F21Y 2101/02

(57) ABSTRACT

Various applications and customizations of a thin flexible LED light sheet are described. Microscopic LED dice are printed on a thin substrate, and the LEDs are sandwiched between two conductor layers to connect the LEDs in parallel. The conductor layer on the light emitting side is transparent. In one embodiment, the light sheet is applied to the bottom surface of a controllable display to serve as a backlight. In another embodiment, the light sheet is applied to the edge of a leaky light guide for backlighting. In another embodiment, a thin light-emitting edge of the light sheet is coupled to the edge of the leaky light guide for backlighting. In another embodiment, the light sheet is affixed to a medical instrument, and light is emitted from a thin light-emitting edge of the light sheet. In one embodiment, the light sheet is optically coupled to an optical fiber.

### CROSS-REFERENCE TO RELATED APPLICATIONS

This application claims the benefit of U.S. provisional application 62/115,508, filed Feb. 12, 2015, and is a continuation-in-part of U.S. application Ser. No. 14/303,410, filed on Jun. 12, 2014, by Travis Thompson et al., assigned to the present assigned and incorporated herein by reference.

### FIELD OF THE INVENTION

This invention relates to various applications for a thin, flexible light emitting diode (LED) light sheet.

### BACKGROUND

The present assignee has previously invented a flat light sheet formed by printing microscopic vertical LED dice over a conductor layer on a flexible substrate to electrically contact the LED's bottom electrodes, then printing a thin dielectric layer over the conductor layer which exposes the LED's top electrodes, then printing another conductor layer to contact the LED's top electrodes.

The LEDs may be printed to have a large percentage of the LEDs with the same orientation so the light sheet may be driven with a DC voltage, or the LEDs may be printed so that approximately one-half of the LEDs have one orientation and the other half has the opposite orientation so an AC signal can drive all the LEDs. In either case, a large number of the LEDs dice are connected in parallel.

By using a transparent film as the substrate and making either or both of the conductor layers transparent, light may exit through either surface or both surfaces simultaneously. If the LEDs are GaN-based and emit blue light, a phosphor layer (e.g., YAG) may be deposited over the light emitting surface to cause the light sheet to emit any color light, such as white light. The light sheets may be formed to have a thickness between about 5-13 mils (125-325 microns), including the phosphor layer.

Further detail of forming a light source by printing microscopic vertical LEDs, and controlling their orientation on a substrate, can be found in US application publication US 2012/0164796, titled, Method of Manufacturing a Printable Composition of Liquid or Gel Suspension of Diodes, assigned to the present assignee and incorporated herein by reference.

### SUMMARY

This present disclosure describes various applications of a thin, flexible LED light sheet, where the basic light sheet fabrication technology is disclosed in US 2012/0164796, but where the light sheet itself is customized for each particular application described herein.

In the various applications described herein, the light sheet has a variety of shapes and novel features. The long life of the light sheet, as a result of the long life of LEDs, enables the light sheet to be permanently incorporated in a wide variety of devices.

Some applications of the LED light sheet, customized for the particular application, include:
Automobile interior and exterior lighting;
Backlighting keyboards, keypads, graphics, signs, etc.;
Attraction-getting displays for packaging;
Integrating the light sheet into consumer devices for controls, logos, etc.;
Self-powered disposable lighting units and safety strips with integrated photovoltaic devices and batteries;
Reading lights and other directed lights;
Illuminating the ends of medical devices such as dental devices and endoscopes;
Lining interior walls with flat light sheets;
Illumination under or above shelves;
Modular light sheet sections that interconnect together;
Laminating the light sheet over clothing and shoes for safety and ornamentation;
Using UV LEDs in the light sheet for sanitization;
Creating controllable colors;
Forming light strips as an adhesive tape;
Unrolling light sheets to create portable signs, safety cones, etc.;
Lighting walkways and providing guide paths;
Reflective displays that use either the sun or an LED sheet as the light source;
Color or monochrome addressable displays having printed LEDs in pixel areas;
Light or image sensors having printed photodiodes;
Visual entertainment systems;
Bending or molding the light sheet to achieve desired light emission characteristics;
Building accents;
Illuminating various sporting devices;
Dynamically addressable backlighting of graphics to achieve animation;
Forming 3-D displays by stacking transparent light sheets
Forming ultra-thin backlights for displays or other uses.

Many other applications are contemplated and described.

### BRIEF DESCRIPTION OF THE DRAWINGS

FIG. 1 is a cross-section of a thin, flexible light sheet that has been shaped or otherwise customized for some of the applications described herein. Variations of the light sheet of FIG. 1 are employed depending on the particular application.

FIG. 2 is a top down view of the structure of FIG. 1, where FIG. 1 is taken along line 1-1 in FIG. 2.

FIG. 3 illustrates a shaped light sheet or printed area of LEDs used as a logo or other symbol.

FIG. 4 illustrates an automobile containing customized light sheets for various functions.

FIG. 5 is a cross-sectional view of the light sheet installed behind the automobile's mesh ceiling material for diffused ambient lighting.

FIG. 6 illustrates an automobile visor containing a light sheet.

FIG. 7 illustrates a steering wheel containing a light sheet for backlighting various features.

FIG. 8 illustrates an automobile front seat containing light sheets.

FIG. 9 illustrates a light sheet incorporated into a seat belt receptacle.

FIG. 10 illustrates a light sheet lining the interior walls of a glove box.

FIG. 11 illustrates a light sheet backlighting a console of an automobile.

FIG. 12 illustrates a light sheet backlighting a keyboard.

FIG. 13 illustrates a light sheet backlighting a touch sensor.

FIG. 14 is a cross-sectional view of side-emitting LEDs, as part of a light sheet, whose light is mixed in a mixing chamber to uniformly backlight graphics.

FIG. 15 is a cross-sectional view of a folded light sheet for mixing light to create a more uniform emission, such as for backlighting.

FIG. 16 illustrates a light sheet as part of packaging or an insert for a package to attract potential consumers to the product.

FIG. 17 illustrates a light sheet forming a logo for the product itself, rather than its package, where the logo may be directly formed by the light sheet or backlit by the light sheet.

FIG. 18 illustrates a self-powered disposable light sheet.

FIG. 19 illustrates a light strip affixed to glasses.

FIG. 20 is a cross-section of an edge-emitting light sheet surrounding a fiber optic cable for an endoscope or other device.

FIG. 21 illustrates an endoscope employing the edge-emitting light sheet of FIG. 20.

FIG. 22 illustrates the edge-emitting light sheet attached to the end of a dental tool.

FIG. 23 illustrates a refrigerator or a cabinet using light sheets on its walls or shelves to illuminate its interior.

FIG. 24 illustrates a light strip applied to the edge of a light-guiding shelf to illuminate objects on the shelf.

FIG. 25 illustrates how a light sheet may be temporarily unrolled for use, then rolled up for compactness.

FIG. 26 illustrates how a light strip may be used to illuminate a photograph in a frame.

FIG. 27 illustrates how a light strip may be used to illuminate the fronts of objects on a shelf.

FIG. 28 illustrates how multiple light sheets may be physically and electrically connected together.

FIG. 29 is a cross-section of two light sheets being electrically connected together, where an attractive force is provided by magnets.

FIG. 30 illustrates a glove having light sheets at tips of the fingers and thumb for illuminating objects being handled.

FIG. 31 illustrates a shoe insert comprising a light sheet containing UV LEDs for killing bacteria.

FIG. 32 illustrates a shoe having a light sheet at its tip for illuminating an area in front of the shoe.

FIG. 33 illustrates a light sheet provided on an article of clothing for safety and/or illumination.

FIG. 34 illustrates a self-powered light sheet containing a photovoltaic cell and a rechargeable battery.

FIG. 35 is a cross-section of one type of reflective display that uses either the sun or LEDs as the light source.

FIG. 36 is a cross-section of another type of reflective display the uses either the sun or LEDs as the light source, where the LEDs are provided along the edges of the display.

FIG. 37 illustrates an addressable display where LEDs are printed in pixel areas.

FIG. 38 illustrates a color pixel in an addressable display, where LEDs are printed in sub-pixel areas for providing controllable red, green, and blue wavelengths.

FIG. 39 is a cross-section of a color pixel comprising layers of red, green, and blue LEDs.

FIG. 40 illustrates how very thin LED display panels may be interconnected for customizing the size of a display screen.

FIG. 41 illustrates an image or light sensor containing an array of printed photodiodes instead of LEDs.

FIG. 42 illustrates a speaker with a light sheet affixed to the moving cone of the speaker and controlled by a piezoelectric element for creating lighting effects.

FIGS. 43A and 43B illustrate a device that changes color over time using a light sheet as the central light source and phosphor particles in a liquid surrounding the light source.

FIG. 44 illustrates an airplane interior light formed from the flexible light sheets.

FIG. 45 illustrates a very thin control console that may be used in any vehicle.

FIG. 46 illustrates a scooter with a light sheet wrapped around the post for safety and providing illumination.

FIG. 47 illustrates a bicycle with a light sheet wrapped around any portion of the frame for safety and providing illumination.

FIG. 48 illustrates a rubber tire that is formed of a translucent material and a light sheet or strip in the hub for illuminating the tire for safety or for adornment.

FIG. 49 illustrates the back of an airplane seat having a fold-up or down light sheet provided above the standard tray for use by the passenger for reading.

FIG. 50 illustrates speaker enclosures with light strips mounted around the speakers.

FIG. 51 illustrates a conventional programmable smartphone controlling the light emitted by a light sphere.

FIG. 52 illustrates a cover for a smartphone, where light sheet sections are in the cover and are controlled either by the smartphone or independently of the smartphone.

FIG. 53 illustrates headphones with external lights.

FIG. 54 illustrates how the light sheet may be incorporated into a game board.

FIG. 55 illustrates light segment pieces of any shape that are connected together in a game.

FIG. 56 illustrates how the lighted game board is adapted to allow players to place interconnecting pieces on it so the light is channeled through the pieces.

FIG. 57 illustrates how the light sheet may be mounted in or on any type of object to highlight the logo.

FIG. 58 illustrates how the light sheet may be laminated on the fronts of skis to illuminate the snow in front of the skis for better visibility.

FIG. 59 illustrates how the thin and flexible light sheets may have a target pattern printed on them for forming lit targets for archery and gunnery.

FIG. 60 illustrates how the thin and flexible light sheets may form part of a camping tent wall for illuminating the inside of the tent.

FIG. 61 illustrates the light sheet on a backpack for safety and illumination.

FIG. 62 illustrates how the rugged light sheet may form part of a projectile and emit light after firing to allow a user to visibly track the path of the projectile.

FIG. 63 illustrates how the light sheet may form an addressable display on a folding emergency road sign.

FIG. 64 is a side view of a light sheet that is folded like an accordion for compactness.

FIG. 65 illustrates a light sheet emitting blue light that is used as an emergency exit sign for better visibility in smoke-filled or particle-filled air.

FIG. 66 illustrates how the light-weight and flexible light sheet can be unfolded and used to create an elevated light source for any purpose.

FIG. 67 illustrates how a very long light strip is initially supported on a roll and cut to any size.

FIG. 68A illustrates a 3-D display formed by stacked transparent light sheets, where LEDs are illuminated along the X, Y, and Z directions like pixels.

FIG. 68B is a cross-sectional view of a small portion of a 3-D display cube showing how full-color pixels may be created using spaced sets of abutting light sheets containing red, green, and blue LEDs.

FIG. 69 illustrates how light strips may be attached under stair railings and on steps to illuminate stairs for safety or aesthetics.

FIG. 70 illustrates a light-emitting block that contains a light sheet, such as along a top wall or along any of the walls, for use in a shower or walkway.

FIG. 71 illustrates the use of the light emitting blocks substituting for conventional bricks along a path.

FIG. 72 illustrates the light strip being laminated on vertical slats of blinds.

FIG. 73 illustrates how the light sheets can be adhesively affixed to fan blades of an overhead fan.

FIG. 74 generally illustrates how a light sheet or light threads may illuminate a carpet or any other textile so that the carpet is a light source.

FIG. 75 illustrates a circular light strip (or other shape of the light sheet) illuminating a lock so it is easier to locate the lock in the dark.

FIG. 76 illustrates the light sheet backlighting a translucent light switch plate.

FIG. 77 illustrates a light strip along a wall of a cabinet.

FIG. 78 illustrates a light strip along a wall of a drawer.

FIG. 79 illustrates a shaped light sheet providing a directional arrow in any building (or even along an airport runway) in the event of an emergency to point out an exit direction.

FIG. 80 illustrates the flexible light sheet being part of a translucent shower curtain.

FIG. 81 illustrates how the light sheet can be along a wall in an aquarium for illuminating the aquarium or used as plant grow lights.

FIG. 82 illustrates how the light sheet or light strips are mounted in a frame for illuminating a picture.

FIG. 83 illustrates how the light sheet may be positioned within the air vent of a refrigerator for illuminating the floor.

FIG. 84 illustrates shelves for supporting objects, where a light strip is mounted (such as adhesively) near the front edge of each shelf on the top and bottom of the shelf.

FIG. 85 illustrates light sheets forming or backlighting letters on street signs.

FIG. 86 illustrates a realtor sign that includes printed graphics and an addressable display displaying customized information.

FIG. 87 illustrates any consumer product containing a light sheet section that forms a logo or backlights a logo.

FIG. 88 illustrates a luggage having a weight sensor and a warning light.

FIG. 89 illustrates a dynamic sign using the light sheet connected as an addressable display, where the font of the sign is automatically adjusted based on demographics.

FIG. 90 illustrates the light sheet having a standard paper sheet size and being used as a customizable illuminated sign, where the user prints a graphics pattern on the light sheet using a standard laser or inkjet printer.

FIG. 91 illustrates how the light sheet may be formed to provide a light source on the frames of protective glasses, prescription glasses, sunglasses, etc.

FIG. 92 illustrates how the light sheet may be used as a headlamp on a hardhat or on any other hat for illumination or safety.

FIG. 93 illustrates how the light sheet may be affixed to a vest for illumination or safety.

FIG. 94 illustrates how the light sheet may be used on a resilient headband or wristband for illumination or safety.

FIG. 95 illustrates how the light sheet may be used on a shirt or vest to provide directional signals while riding a bicycle.

FIG. 96 illustrates a cap with the light sheet located under the brim for providing down light for illumination.

FIG. 97 illustrates how the light sheet may be used along an inside wall of a handbag to illuminate the contents.

FIG. 98 illustrates how a light strip within a translucent portion of a pacifier allows the pacifier to be easily found if dropped.

FIG. 99A illustrates a curved light sheet with a central power track that may use mains voltage and replace a vanity mirror lamp.

FIG. 99B illustrates the electrical connection of the vanity mirror lamp to the mains voltage using an Edison type connector.

FIG. 99C illustrates how each conventional vanity lamp bulb can be directly replaced with a curved light sheet.

FIG. 100A is a cross-sectional view of a color tunable lamp using LEDs in opposite orientations in a light sheet.

FIG. 100B illustrates possible waveforms for energizing the two different orientations of LEDs in the light sheet to combine the colors associated with the two sets of LEDs.

FIG. 101 is a cross-sectional view of the light sheet backlighting a display layer with a diffuser film therebetween to form an ultra-thin display.

FIG. 102A is a cross-sectional view of a light sheet (formed as a narrow strip), similar to that shown in FIG. 20, where all light is emitted from a thin edge of the light sheet.

FIG. 102B is a top down view of a small portion of the light sheet of FIG. 102A, with the top reflector layer invisible, showing light rays emitted from the edge.

FIG. 103 is a cross-sectional view of an edge-emitting light sheet having reflective optics that direct light toward the light-emitting edge of the light sheet.

FIG. 104 is a cross-sectional view of an ultra-thin display, where light from the edge of the light sheet of FIG. 102 is coupled into the edge of a leaky light guide for backlighting a controllable display layer.

Elements that are similar or identical in the various figures are labeled with the same numeral.

### DETAILED DESCRIPTION

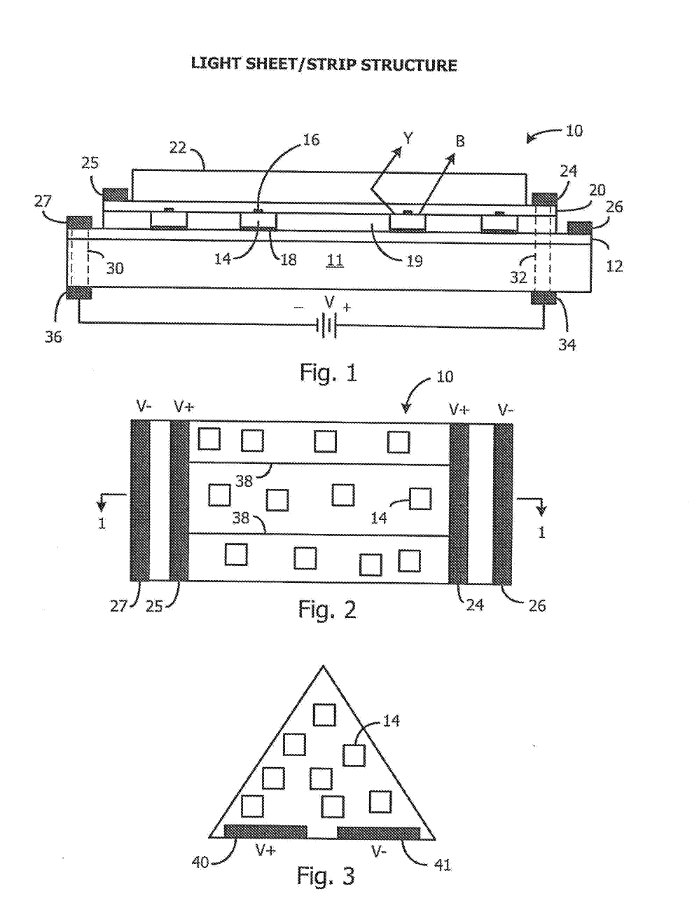

In one embodiment of the invention, a highly flexible and thin light sheet containing microscopic LED dice is customized for a particular application. The light sheet may have a thickness between 5-13 mils, including a phosphor layer, which is on the order of the thickness of a sheet of paper or cloth. FIGS. 1 and 2 illustrate a light sheet 10 that may form part of the light sheet employed in any of the applications described herein. The shape of the light sheet 10, the pattern of printed LEDs, and certain features are customized for the particular application.

In FIG. 1, a starting substrate 11 may be polycarbonate, PET (polyester), PMMA, Mylar or other type of polymer sheet, or even a thin metal film, paper, cloth, or other material. In one embodiment, the substrate 11 is about 25-50 microns thick.

A conductor layer 12 is then deposited over the substrate 11, such as by printing. The substrate 11 and/or conductor layer 12 may be reflective if the light from the LEDs is to only be emitted from the opposite side. For example, the conductor layer 12 may be a printed aluminum layer or a laminated aluminum film. Alternatively, a reflective layer may be first laminated over the substrate 11 followed by printing a transparent conductor layer 12 over the reflective film. A reflective film, including a white diffusing paint, may also be provided on the back surface of the substrate 11. A suitable transparent conductor layer 12 may be a silver nano-wire layer since such a layer is highly flexible.

A monolayer of microscopic inorganic LEDs 14 is then printed over the conductor layer 12. The LEDs 14 are vertical LEDs and include standard semiconductor GaN layers, including an n-layer, and active layer, and a p-layer. GaN LEDs typically emit blue light. The LEDs 14, however, may be any type of LED emitting red, green, yellow, or other color light.

The GaN-based micro-LEDs used in embodiments of the present invention are less than a third the diameter of a human hair and less than a tenth as high, rendering them essentially invisible to the naked eye when the LEDs are sparsely spread across the substrate 11 to be illuminated. This attribute permits construction of a nearly or partially transparent light-generating layer made with micro-LEDs. In one embodiment, the LEDs 14 have a diameter less than 50 microns and a height less than 10 microns. The number of micro-LED devices per unit area may be freely adjusted when applying the micro-LEDs to the substrate 11. A well dispersed random distribution across the surface can produce nearly any desirable surface brightness. Lamps well in excess of 10,000 cd/m² have been demonstrated by the assignee. The LEDs may be printed as an ink using screen printing or other forms of printing. Further detail of forming a light source by printing microscopic vertical LEDs, and controlling their orientation on a substrate, can be found in US application publication US 2012/0164796, entitled, Method of Manufacturing a Printable Composition of Liquid or Gel Suspension of Diodes, assigned to the present assignee and incorporated herein by reference.

In one embodiment, an LED wafer, containing many thousands of vertical LEDs, is fabricated so that the top metal electrode 16 for each LED is small to allow light to exit the top surface of the LEDs. The bottom metal electrode 18 is reflective (a mirror) and should have a reflectivity of over 90% for visible light. There is some side light, depending on the thickness of the LED. In the example, the anode electrode is on top and the cathode electrode is on the bottom. In other embodiments, the top electrode may cover the entire surface of the LED and is reflective, and light exits the bottom of the LED through a transparent conductor layer 12 and a transparent substrate 11. In another embodiment, the electrodes are formed so that light exits both surfaces, and the lamp emits light though both surfaces of the light sheet.

The LEDs are completely formed on the wafer, including the anode and cathode metallizations, by using one or more carrier wafers during the processing and removing the growth substrate to gain access to both LED surfaces for metallization. The LED wafer is bonded to the carrier wafer using a dissolvable bonding adhesive. After the LEDs are formed on the wafer, trenches are photolithographically defined and etched in the front surface of the wafer around each LED, to a depth equal to the bottom electrode, so that each LED has a diameter of less than 50 microns and a thickness of about 4-8 microns, making them essentially invisible to the naked eye. A preferred shape of each LED is hexagonal. The trench etch exposes the underlying wafer bonding adhesive. The bonding adhesive is then dissolved in a solution to release the LEDs from the carrier wafer. Singulation may instead be performed by thinning the back surface of the wafer until the LEDs are singulated. The LEDs 14 of FIG. 1 result, depending on the metallization designs. The microscopic LEDs 14 are then uniformly infused in a solvent, including a viscosity-modifying polymer resin, to form an LED ink for printing, such as screen printing, or flexographic printing.

The LEDs 14 may instead be formed using many other techniques and may be much larger or smaller. The lamps described herein may be constructed by techniques other than printing.

The LED ink is then printed over the conductor layer 12. The orientation of the LEDs 14 can be controlled by providing a relatively tall top electrode 16 (e.g., the anode electrode), so that the top electrode 16 orients upward by taking the fluid path of least resistance through the solvent after printing. The anode and cathode surfaces may be opposite to those shown. The LED ink is heated (cured) to evaporate the solvent. After curing, the LEDs remain attached to the underlying conductor layer 12 with a small amount of residual resin that was dissolved in the LED ink as a viscosity modifier. The adhesive properties of the resin and the decrease in volume of resin underneath the LEDs 14 during curing press the bottom cathode electrode 18 against the underlying conductor layer 12, creating a good electrical connection. Over 90% like orientation has been achieved, although satisfactory performance may be achieved with over 75% of the LEDs being in the same orientation.

A dielectric layer 19 is then selectively printed over the conductor layer 12 to encapsulate the sides of the LEDs 14 and further secure them in position. The ink used in the dielectric layer 19 pulls back from the upper surface of the LEDs 14, or de-wets from the top of the LEDs 14, during curing to expose the top electrodes 16. If any dielectric remains over the LEDs 14, a blanket etch step may be performed to expose the top electrodes 16.

A transparent conductor layer 20 is then printed to contact the top electrodes 16. The conductor layer 20 may be ITO or may include silver nano-wires. The conductor layer 20 is cured by lamps to create good electrical contact to the electrodes 16. Since ITO is relatively brittle, it is preferred to use a cured silver nano-wire solution to form the transparent conductor layer 20. The curing sinters overlapping silver nano-wires together to form a flexible 3-dimensional mesh of wires have large openings for allowing light to pass through.

The LEDs 14 in the monolayer, within a defined area, are connected in parallel by the conductor layers 12/20 since the LEDs 14 have the same orientation. Since the LEDs 14 are connected in parallel, the driving voltage must approximately equal the voltage drop of a single LED 14.

Many other ways can be used to form the LEDs 14, and the LEDs 14 do not need to be microscopic or printed for the present invention to apply.

A flexible, protective layer (not shown) may be printed over the transparent conductor layer 20. If wavelength conversion is desired, a phosphor layer 22 may be printed over the surface. The phosphor layer may comprise phosphor powder (e.g. a YAG phosphor) in a transparent flexible binder, such as a resin or silicone. In one embodiment, the phosphor layer 22 is conductive, such as by containing sintered nano-wires, so a separate transparent conductor layer 20 is optional, and electrical access to the LEDs is made easier by just contacting the phosphor layer. In another embodiment, the layer 22 may represent a diffuser layer to eliminate any perceived sparkle from the microscopic LEDs. A phosphor layer also acts as a diffuser.

The flexible light sheet 10 of FIG. 1 may be any size and may even be a continuous sheet formed during a roll-to-roll process that is later stamped out for a particular application.

FIGS. 1 and 2 also illustrate how the thin conductor layers 12 and 20 on the light sheet 10 may be electrically contacted along their edges by metal bus bars 24-27 that are printed and cured to electrically contact the conductor layers 12 and 20. The metal bus bars along opposite edges are shorted together by a printed metal portion outside of the cross-section. The structure may have one or more conductive vias 30 and 32 (metal filled through-holes), which form a bottom anode lead 34 and a bottom cathode lead 36 so that all electrical connections may be made from the bottom of the substrate 11. Instead of vias, the top metal may be connected to the bottom metal by other means, such as metal straps extending over the edges of the light sheet. A suitable voltage differential applied to the leads 34 and 36 turns on the LEDs 14 to emit light through one or both surfaces of the light sheet 10.

FIG. 2 is a top down view of the light sheet 10 of FIG. 1, where FIG. 1 is taken along line 1-1 in FIG. 2. If the light sheet 10 is wide, there will be a significant IR drop across at least the transparent conductor layer 20. Thin metal runners 38 may be printed along the surface of the conductor layer 20 between the opposing bus bars 24 and 25 to cause the conductor layer 20 to have a more uniform voltage, resulting in more uniform current spreading. In an actual embodiment, there may be thousands of LEDs 14 in a light sheet 10.

FIG. 3 illustrates how the light sheet or the printed pattern of LEDs 14 may be made into any arbitrary shape, such as a product's logo, with metal leads 40 and 41 for receiving a driving voltage.

To show the wide range of uses of the basic light sheet 10 structure, the various figures are grouped into categories, including automobile applications, backlighting applications, packaging applications, illumination of objects applications, interconnection features, clothing and textile applications, safety applications, addressable display applications, and entertainment applications. Additional embodiments and applications are described herein.

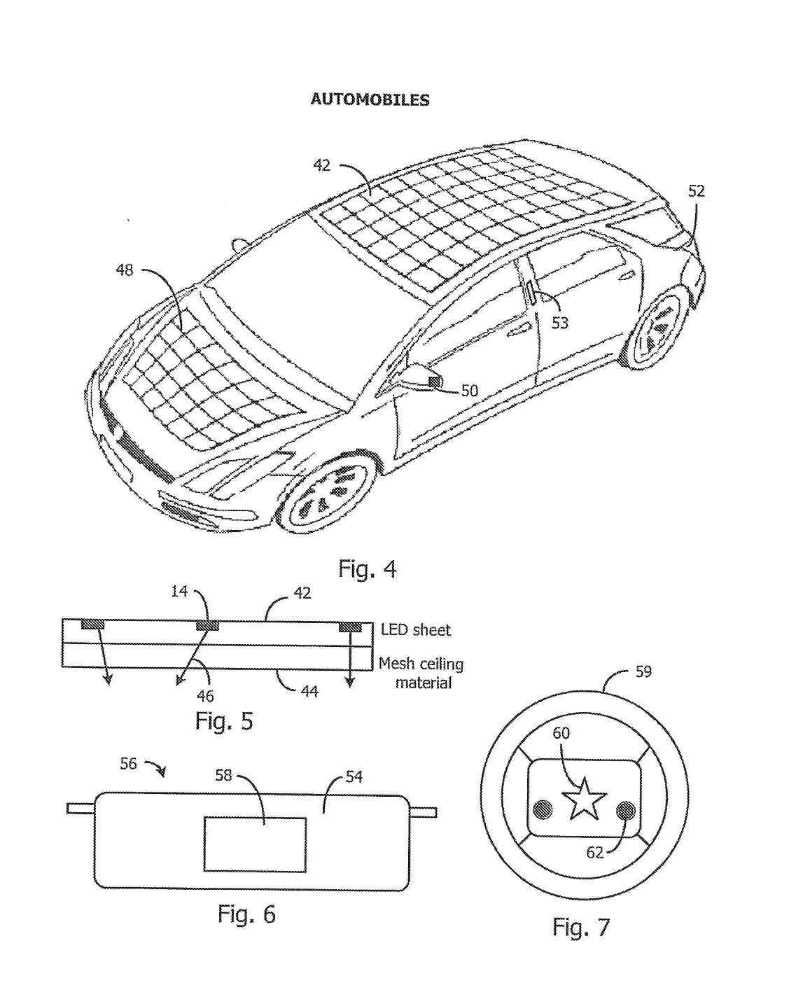

FIG. 4 is a perspective view of an automobile using the LED light sheet for various functions.

For a diffused ambient light that is not distracting to the driver, a wide area LED light sheet 42 is provided in the interior of the automobile behind the conventional translucent ceiling material. In such a case, the light sheet 42 cannot be seen through the ceiling material in the off-state. Since the light is spread out, there is no glare for the driver. This technique obviates the need for a central overhead bright light bulb in the ceiling, which is generally distracting to the driver, creates shadows, and requires a reflective housing.

FIG. 5 is a cross-sectional view of a portion of the light sheet 42 behind a typical translucent automobile ceiling material 44, where the light rays 46 pass through and become diffused by the ceiling material 44. Ceiling material for an automobile is typically a thin sheet of polyester and is typically woven or has an array of pin holes punched through it. In either case, the openings in the weave or the holes allow the LED backlight to directly pass through, and the polyester material itself is typically translucent, so light from the light sheet 42 effectively illuminates the entire backlit ceiling of the automobile. The weave or hole density may be selected to allow a desired amount of light to pass directly through the openings in the material.

A phosphor layer on the light sheet 42, or the LED color itself, may be adjusted to offset any color component added by the ceiling material so the diffused light appears white or has substantially the desired target color temperature. This may be done by selecting the phosphor type(s) and/or the density and thickness of the phosphor. Multiple color LEDs may be used in the light sheet, and the RGB components can be individually controlled, to allow the resulting color to either achieve a target color temperature or to allow the user to select the illumination color. Controlling the color of a light sheet is also described with respect to FIGS. 38 and 39, and such a technique may be used for the light sheet 42.

Any standard sound/temperature insulating material may be inserted behind the light sheet 42. Typically, there will be an air gap between the ceiling material and the light sheet 42 so the characteristics of the ceiling material are unaffected. This illumination technique may be employed with little or no change to the existing interior of the automobile. In another embodiment, the light sheet 42 is laminated to the back of the ceiling material 44 prior to the ceiling material 44 being installed in the automobile.

In one embodiment, the light sheet 42 backlights over 75% of the ceiling material 44. In another embodiment, the light sheet 42 backlights over 50% of the ceiling material 44.

In one embodiment, the light sheet 42, or multiple light sheets, overlie the rear passenger area, the front passenger area, and the driver area. The light sheet(s) over each area is separately controllable by switches so that only the person that desires the light is illuminated by the overhead light.

In one embodiment, the color of the light sheet(s) may be controlled by using different phosphor areas or different colors of LEDs, as described above, and the color of the light may be controlled by the driver or passenger depending on the particular use of the light. For example, for driving at night, a passenger may want the illumination to be redder to minimize interference with the driver's vision. If the passenger wanted a brighter light for reading, the passenger would control the emission color to add green and blue components to create a whiter light.

In another embodiment, the light from the light sheet 42 is dimmable by use of an appropriate PWM controller.

This same technique can be used to illuminate any vehicle, such as vans, trucks, etc., or any other structure that uses a thin translucent ceiling material.

To avoid the use of any power converter, multiple light sheets, such as four, can be connected in series to achieve a voltage drop of approximately 12 volts, which is a typical automobile battery voltage. The ceiling light may automatically turn on when a door is opened, or can be manually controlled. In one embodiment, the light sheet 42 does not extend forward of the driver's eyes so as not to interfere with the driver's vision at night. The light sheet 42 may cover anywhere up to 100% of the ceiling area. Since the light sheet 42 is extremely thin and flexible, no other modifications need to be made to the automobile to add the light sheet feature.

An additional light sheet 48 may be installed in the hood (to illuminate the engine) and in the trunk, which is energized when the hood or trunk is opened. The broad area light provides better illumination than the conventional bulbs mounted on hoods and trunks.

The light sheet may be formed to have a high brightness per unit area so can be used as turn signals on the side mirrors (light sheet 50) and as a rear or front wrap-around light 52 of any color for use as a stop light, a turn signal, a reverse light, a daytime running light, etc. A light sheet may also illuminate the license plate or form a logo of the automobile. The light sheets may be adhesively applied to the exterior of the automobile or provided behind a transparent window.

The floor or the area around the floor may also be illuminated with light sheets.

Unlike a bulb, the light sheets do not need a robust electrical receptacle, or a reflector, or a protective housing. Therefore, there is minimal impact on the automobile design to accommodate any number of the light sheets. Further, the life of an LED typically outlasts the life of the automobile, so the light sheets may be permanently installed.

LED strips may also be affixed to the bottom edge of each door and automatically illuminated when the door is opened to uniformly illuminate the stepping area around the automobile. These types of lights are sometimes referred to as puddle lights. LED light strips may also be affixed to the running boards, or sills, opposing the bottom of the doors.

The inside and outside door handles may also be formed to include LED light strips to show the handles at night. The colors of the light strips may be controlled to indicate whether the car is locked or unlocked. The light sheets may be used to backlight any translucent portion of the automobile.

An LED light sheet may also backlight a keyless entry touch pad 53 located on the column between the doors.

The LED light sheet may also illuminate the inside of a cup holder and the gear shift area, or any other object that is to be illuminated at night. Power may be applied when the driver turns on the headlights.

FIG. 6 illustrates how a light sheet 54 forms the front of an automobile's flip-down visor 56. The LEDs are illuminated automatically when the visor 56 is flipped down. A center mirror 58 is also shown.

For safety reasons, the hub of the steering wheel should be soft. In modern cars, the steering wheel contains various controls, such as speed controls, audio controls, and horn controls. FIG. 7 illustrates a steering wheel 59 with a center hub containing controls that are backlit by the flexible LED light sheet. The car's logo 60 is dimly lit and the horn buttons 62 are visible at night by backlighting from a single light sheet. Any other controls may be backlit from the same flexible light sheet, and the LEDs may only be printed in areas aligned with the items to be backlit to save power and reduce cost.

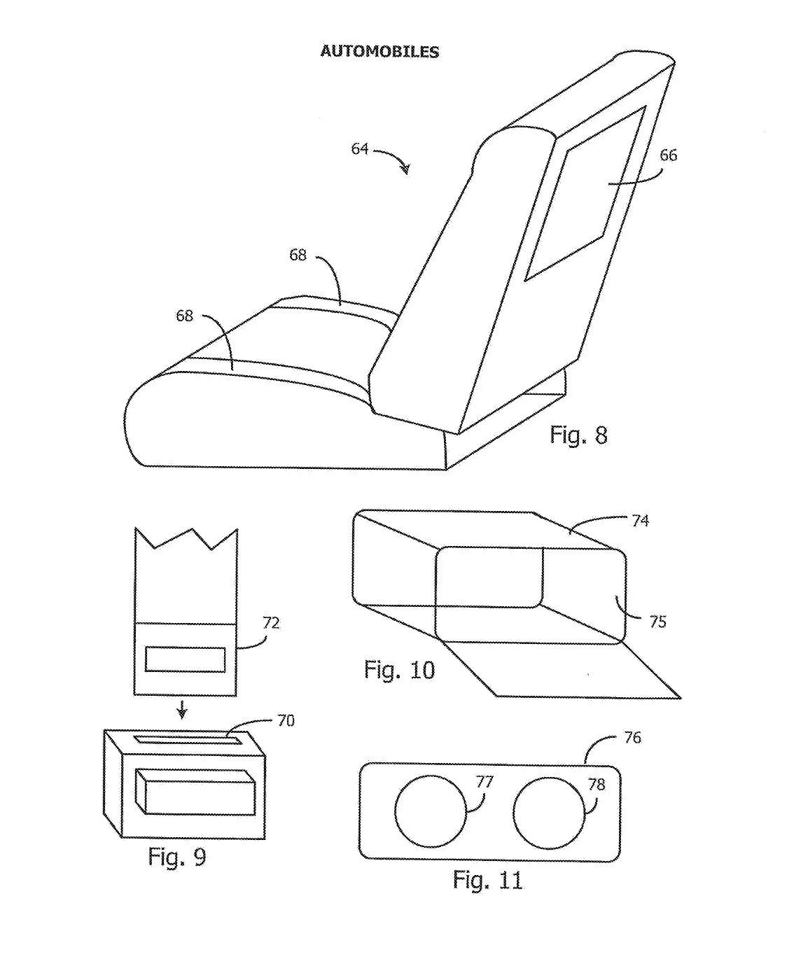

FIG. 8 illustrates how the back of the front seats 64 may have an LED light sheet 66 laminated to the back of it for use by the rear seat passengers. Unlike the harsh glaring light of a bulb, the light sheet 66 provides a highly diffused light at a fraction of the cost of the bulb lamp and has a reliability that allows the light sheet 66 to be permanently affixed to the seat 64.

FIG. 8 also shows LED light strips 68 on the seat itself. The thinness and flexibility of the light strips 68 allows this application.

FIG. 9 illustrates how a small LED light sheet may be incorporated in the seat belt receptacle 70 so the passenger knows where to insert the seat belt buckle 72 in the dark. Power is already applied to the receptacle 70 for detecting the insertion of the buckle 72 so there is no additional wiring needed to power the light sheet.

Since the light sheet is thin and flexible, it may cover the inner top and side walls of a glove box 74, shown in FIG. 10. Unlike conventional bulbs in glove boxes, the wide area light from the light sheet 75 is not blocked by objects in the glove box 74.

FIG. 11 illustrates how a single LED light sheet may backlight an entire console 76 of an automobile. A speedometer 77 and tachometer 78 are shown. Although LED are commonly used in automobiles in the same way bulbs were used, such LEDs are typically used to couple light to a lightguide, where the lightguide leaks the light in the direction of the driver. However, with the LED light sheet, the light is inherently diffused and directed forward, obviating the need for any lightguide. This characteristic creates many additional possibilities for lighting.

Backlighting for devices other than in automobiles is next described, using the basic light sheet structure of FIG. 1.

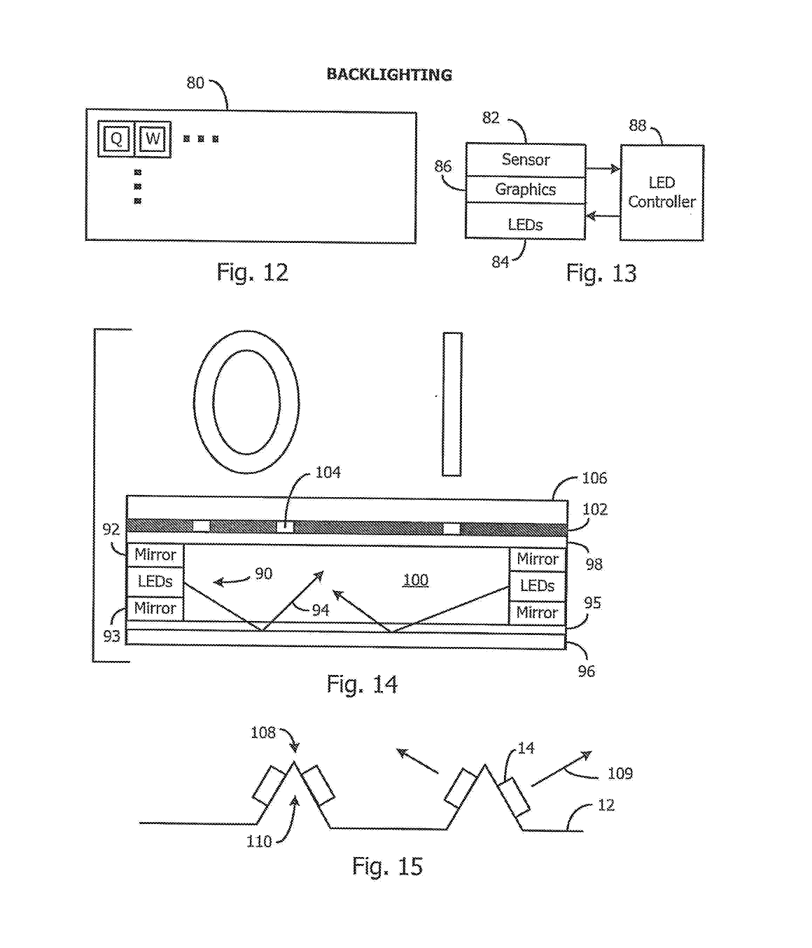

FIG. 12 illustrates the LED light sheet backlighting a conventional QWERTY keyboard 80. The LEDs may be printed in only those areas on the substrate 11 (FIG. 1) that are directly behind a character to be backlight to preserve power and cost. In the example, opaque graphics are molded into the keyboard and keys that define openings for the letters as well as an outline of the keys. Conventional backlit keyboards include lightguides that are more complex to incorporate as backlights.

FIG. 13 illustrates a transparent capacitive touch sensor layer 82 laminated over, or integrated with, an LED light sheet 84 to backlight a graphics layer 86. The graphics layer 86 may instead be over the sensor layer 82. The graphics layer 86 is an opaque layer having openings defining symbols, such as alphanumeric characters. There may be a diffusive layer over the graphics layer 86 so the user cannot see the graphics except when the device is backlit. When an LED controller 88 senses a touch or a finger proximate to the sensor layer 82, the LEDs are illuminated. This allows the keypad or other device to be essentially invisible until needed for aesthetic purposes. This is called a dead-front. The controller 88 may then serve as a conventional touch sensor controller for processing the keypad selections.

FIG. 14 is a cross-section of a small portion of a backlit display or keypad, which may include a touch sensor layer, such as shown in FIG. 12. The LEDs 90 are formed to have top and bottom metal mirror electrodes 92 and 93 so that all light 94 is emitted from the sides of the LEDs 90 toward the middle of the structure. The LEDs 90 are printed over a transparent conductor layer 95 having an underlying reflector layer 96. The LEDs 90 are only printed along the edges of the light sheet. The top electrodes of the LEDs 90 are electrically contacted by another transparent conductor layer 98. Between the opposing strips of LEDs 90 is a transparent dielectric layer 100. The reflector layer 96 and/or the surfaces of the dielectric layer 100 may be diffusive, such as obtained by roughening, so that the light is mixed within the dielectric layer 100 to create a uniform brightness along the top surface of the dielectric layer 100. A layer of opaque graphics 102, printed over the transparent conductor layer 98, has openings 104 which define symbols, such as alphanumeric characters. A reflective layer may be printed below the opaque portions to reduce light absorption. Therefore, a uniform brightness light is emitted through the openings 104. A top diffuser layer 106 further mixes the light and may be used to cause the graphics to be invisible until backlit. In the example, the numbers 0 and 1 are displayed by the structure, which may be part of a touch sensor keypad.

Alternatively, narrow strips of the LEDs are affixed around the edges of the structure and inject light in from the sides, in which case the LEDs are not side-emitting types.

FIG. 15 illustrates an alternative way of mixing light to create a uniform brightness emission for backlighting. A flat light sheet is formed, such as shown in FIG. 1, with printed LEDs 14 sandwiched between two conductor layers (only the bottom conductor layer 12 is shown in FIG. 15). The light sheet is then bent or molded to create parallel rows of angles 108 so the LEDs 14 primarily emit light 109 at shallow angles to mix the light within a spacer layer, which may be an air layer. The folds may be retained by an adhesive injected into the concave areas 110. Alternatively, a heated mold may permanently deform the light sheet layers. The structure may then be used to backlight a graphics layer, such as the graphics layer 102 of FIG. 14.

Packaging applications using the basic light sheet structure of FIG. 1 are next described.

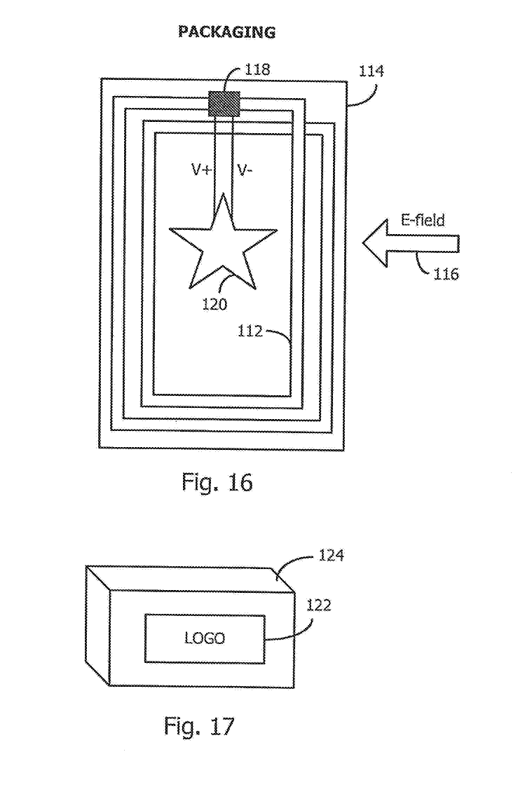

FIG. 16 illustrates a portion of the outer or inner surface of a package for containing a consumer product, such as a razor. Alternatively, FIG. 16 may illustrate an insert for a transparent package. All elements are printed. A spiral metal trace 112 is printed on an opaque or transparent thin flexible substrate 114. The trace 112 forms an inductor, and a constant or intermittent electromagnetic field 116 generated by the store's display case proximate to the package induces a current in the trace 112. A rectifier circuit 118 (an IC) converts the AC current generated by the trace 112 into a DC voltage, and the DC voltage is applied to the leads of a patterned LED layer 120 printed over the same substrate 114. In the example, the LEDs are printed in a star pattern, which may be a logo of the product. The circuit 118 may also include a current limiter. The LEDs may be the same as the LEDs 14 in FIG. 1, and the same printing step that formed the trace 112 may also form the bottom conductor layer for the LEDs. A transparent conductor layer forms the top conductor for the LEDs. The patterning may be by screen printing, flexography, or other technique. Thus, when the field 116 is generated, the LEDs forming the pattern are automatically illuminated to draw attention to the product, increasing sales. The circuit 118 may also include a state machine that controls segments of printed LEDs to create an animation inside or outside the package.

FIG. 17 generally depicts how the LEDs in the LED light sheet 122 may be printed to display any logo on the product 124 itself. The LED pattern may directly depict the logo, or the logo may be backlit by the LEDs. The light sheet 122 may be molded directly into the product, such as the outer plastic housing of an appliance, and possibly be protected by a transparent plastic window. Since LEDs have a very long lifetime and there is high redundancy in the LED light sheet (since thousands of LEDs may be connected in parallel), the light sheet may be a permanent and integral part of the product.

General illumination applications using the basic light sheet structure of FIG. 1 are next described.

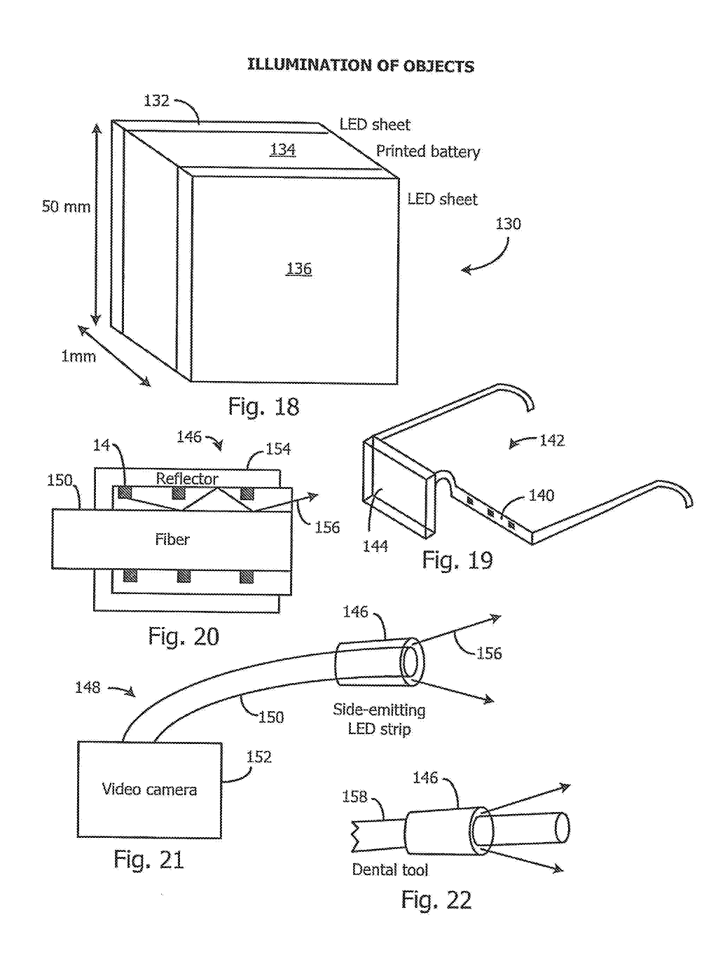

FIG. 18 illustrates a very inexpensive disposable lighting device 130 that may serve to substitute for disposable chemical glow-sticks, for example. Many such disposable devices 130 may be provided in a single package. The various layers may be laminated together or printed over the same substrate. In the example, the device 130 is relatively small, such as 50 mm per side and 1 mm thick, and is sold as a stack. The devices may be formed in large sheets and stamped out for singulation. A first LED light sheet 132 is formed over a transparent substrate. A lithium ion battery 134, or other type of known printable battery, is printed over the light sheet 132 or laminated over it. A second LED light sheet 136 is then printed over or laminated over the battery 134. The battery life may be anywhere from 15 minutes to 2 hours or more depending on the current drawn by the LEDs and the size of the battery. Various illumination times may be offered. A weak adhesive may be provided on the back of each device 130. Instead of two light sheets being used, only one light sheet may be used for a Lambertian emission. The electrical connections between the battery 134 and the light sheets may be side connectors, or conductive vias through the various layers may be used. By bending the device 130 or removing the device 130 from a dispenser, an electrical connection is made between the battery 134 and the light sheets 132/136 to illuminate the LEDs. In one embodiment, bending the device 130 causes two metal strips to connect together to initiate current flow through the LEDs. The device 130 is then disposed of after the battery 134 has been depleted.

In an alternative embodiment, a set of the devices 130 is provided in a package having a photovoltaic cell that keeps the batteries 134 of all the devices 130 constantly charged. When one of the devices 130 is removed from the pack, the battery 134 is electrically coupled to the LEDs to turn on the removed device 130.

FIG. 19 illustrates an LED light strip 140 affixed to the front of “smart” glasses 142, such as Google Glass™, to illuminate objects. The glasses 142 may be equipped with a video camera and forms a screen using the lens 144. The LEDs are automatically illuminated for adequate capture of images.

In some applications of the LED light sheet technology, the light must be emitted from the thin edges of the light sheet. FIG. 20 illustrates how a light sheet may emit primarily from its edge. In the example of FIG. 21, the light sheet 146 is the light source of an endoscope 148. A conventional endoscope, for insertion into a body cavity, includes a relatively thick central fiber optic cable for optically coupling an image to a remote video camera. In such a conventional endoscope, a relatively thick outer fiber optic layer, concentric with the video fiber, is coupled to a high brightness remote light source that couples light into one end of the fiber optic layer. The light exits the other end of the fiber to illuminate the area in front of the video fiber end to view the inside of the body cavity. It is desirable that the composite cable be thin and the light be bright despite the losses through the cable.

In the example of FIG. 21, all light produced by the thin LED light sheet 146 (e.g., less than 1 mm) is directed toward the front of the conventional video fiber 150. A video camera 152 detects the image in front of the end of the fiber 150. The light sheet 146 may be a strip that is wrapped around the end of the fiber 150 multiple times to achieve the desired brightness, or the length of the light sheet and density of the LEDs may be selected to generated the required light using only one layer. Thin, flat conductors are affixed along the length of the fiber 150 to supply power to the LEDs. Any phosphor need only be located at the thin exit area of the light sheet, and the type of phosphor used (to select the overall emitted color) may be tailored to the particular use of the endoscope. The light sheet 146 may be replaceable for tailoring the color or brightness.

FIG. 20 is a cross-sectional view of the light sheet 146 over the video fiber 150. The light sheet 146, containing LEDs 14, is covered on all sides except the exit surface, by a thin reflective layer 154, such a metal layer. The fiber 150 may also be covered by a reflective layer if the LED light would otherwise couple into the sides of the fiber 150. The LEDs 14 may be side-emitting LEDs, having mirror electrodes, so all light is directed laterally, but this is not necessary since the reflective layers cause all light 156 to be emitted from the right edge of the light sheet 146.

Since the light sheet 146 may be only a single layer and be of any brightness, the light source for the endoscope adds no significant thickness to the endoscope. Further, there is less attenuation of light since the light source is near the end of the endoscope.

FIG. 22 illustrates another application of the edge-emitting light sheet 146 when affixed at the end of a dental tool 158 or other device where directed illumination is desirable. This avoids the need for an overhead light to illuminate the patient's mouth when using the dental tool 158.

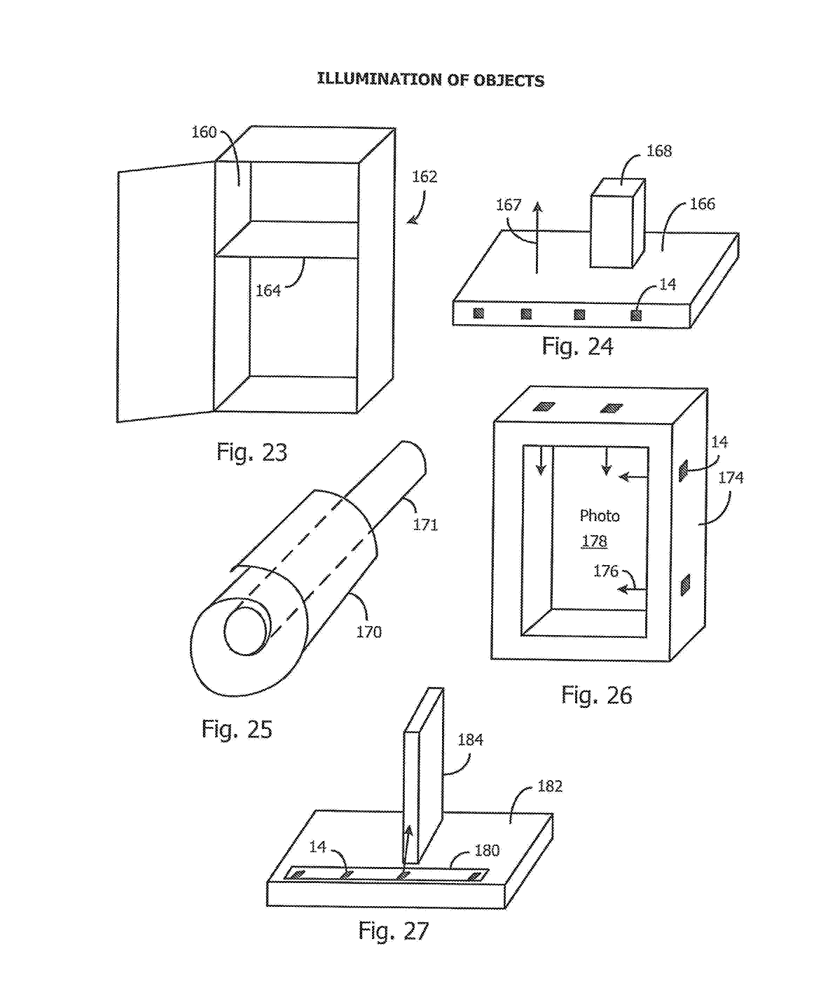

FIG. 23 illustrates an example of applying the LED light sheet 160 to the walls of a cabinet or refrigerator 162 to illuminate all objects in the structure without light blockage by the objects. A light sheet may also be affixed to the bottom of the shelf 164. In a conventional refrigerator, there are only a few small light sources. By using the flat light sheets, the surfaces may be easily cleaned and do not have to be replaced for the life of the refrigerator 162.

FIG. 24 illustrates how a strip of the LEDs 14 may be affixed to the edge of a transparent or translucent glass or plastic shelf 166 in the refrigerator 162 to allow the shelf to act as a lightguide. The top surface of the shelf 166 is textured to uniformly leak out the light 167 to illuminate objects 168 from the bottom up.

FIG. 25 illustrates an application where power is supplied to one edge of the light sheet 170 via a rod 171, and the light sheet 170 may be rolled up and unrolled to select the area of the light sheet 170. The light sheet 170 may be transparent so that, even when rolled up, all light generated is transmitted through the outer surface. This type of structure may be useful for transporting the light sheet 170 in a compact state.

FIG. 26 illustrates LED light strips having LEDs 14 affixed to the side or internal to a picture frame 174. The picture frame 174 may be a transparent or translucent plastic to act as a leaky lightguide. All LED light is directed inward due to a reflective layer on the outer surface of the light strips. The LED light 176 is then directed to the front of a conventional photo positioned in a recess 178 of the frame 174.

FIG. 27 illustrates the use of an LED light strip 180, containing LEDs 14, affixed to the front of a book shelf 182 for illuminating the fronts of books 184.

Many other applications of the light sheet structure for general illumination are envisioned, such as under-cabinet lighting, accent lighting of ceilings, using the flat light strips where ease of cleaning is important, etc.

Since the light sheets can be connected together to increase their effective light emission, various ways for interconnecting such modular light sheets are described below.

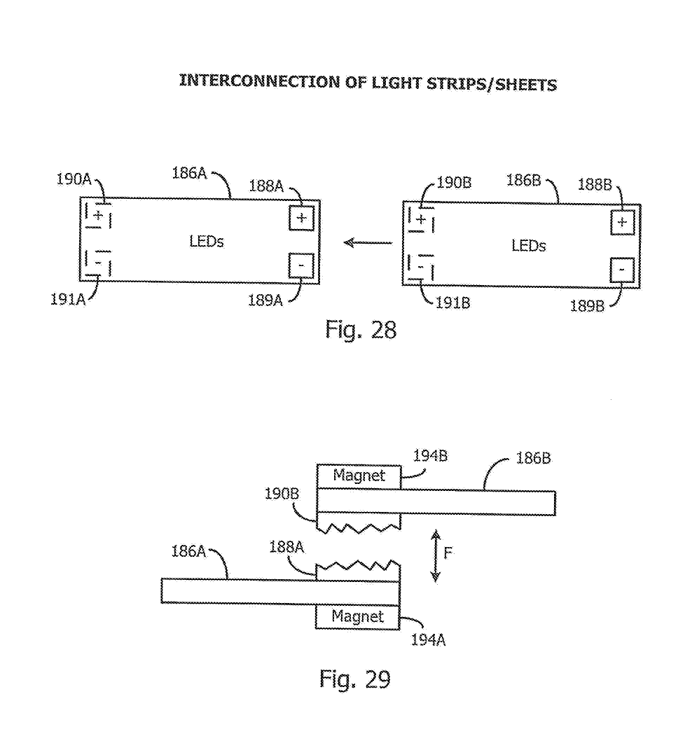

FIG. 28 illustrates identical light strips 186A and 186B containing printed LEDs sandwiched between two conductor layers, such as shown in FIG. 1. The two conductor layers terminate in front electrodes 188A, 189A, 188B, and 189B, and terminate in back electrodes 190A, 191A, 190B, and 191B. To connect the light strips together, the bottom electrodes 190B and 191B are positioned to overlap the top electrodes 188A and 189A. The terminals at either end of the connected light strips are then connected to a power supply. The electrodes may be provided with a weak conductive adhesive, or the technique of FIG. 29 may be used.

In FIG. 29, magnets 194A and 194B are printed opposite to each electrode 188A and 190B. When the electrodes 188A and 190B are brought together, the magnets 194A and 194B provide an attraction force F that ensure a good electrical connection. Further, the electrode surfaces are roughened to effectively increase the force per unit area to improve the electrical contact. The roughened surfaces also increase the frictional forces between the electrodes to withstand a greater lateral pulling force without disengagement.

The edges of the light sheets or strips may also form indentations and protrusions so the light sheets can fit together like puzzle pieces while also making good electrical connections. The connector locations prevent the light sheets from being connected with a reverse polarity. Snaps, clamps, or other mechanisms may also be used to create electrical connections while also providing a good mechanical interlock of the light sheets.

The connections shown cause all the LEDs in the strips to be connected in parallel. If an increased voltage drop is desired, some contacts may be reversed to create series connections between the strips. Each strip drops about 3 volts.

Due to thickness of the light sheet being typically thinner than cloth and resulting in the light sheet being highly flexible, the light sheet is particular suitable for lamination on clothing and textiles, or sewing the light sheet to the clothing or textiles. Applications of the light sheet for some clothing products are described below.

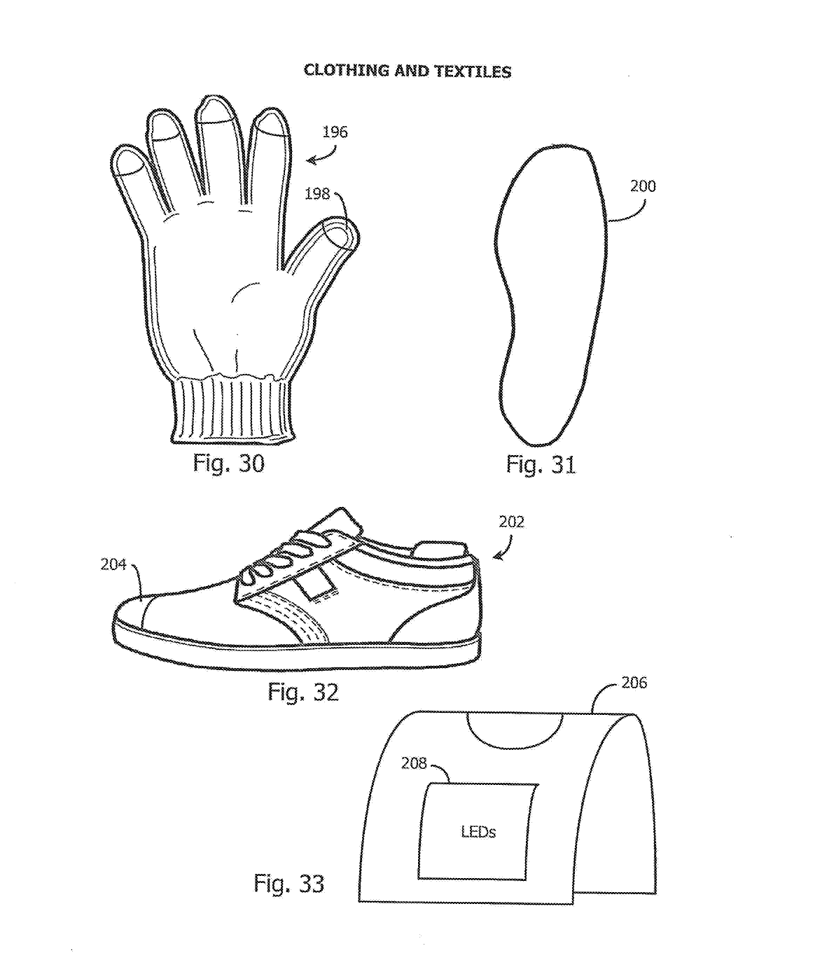

FIG. 30 illustrates a glove 196 equipped with LED light sheet pads 198 at the tips of the fingers and thumb. A small battery pack may be provided on the other side of the glove or external to it with a connector for the pads 198. The light will generally be directed to any task being performed. The glove 196 may be a surgical glove or other type of task glove.

FIG. 31 illustrates a UV LED light sheet shoe sole insert 200 that intermittently supplies UV light to the shoe for killing bacteria within the shoe either when wearing the shoe or while the shoe is off. Using a UV light sheet for other disinfection applications is envisioned, such as providing the UV light sheet in duct work for disinfecting air or for disinfecting water flowing in a pipe or in a fish tank. Such a UV light sheet may also be used as a grow light for plants.

FIG. 32 illustrates a white light LED light sheet 204 located at the tip of a shoe 202 for guidance and safety. A battery pack may be incorporated into the shoe, or a piezoelectric element or other charging mechanism may be used to charge a battery or capacitor for supplying power to the LEDs.

FIG. 33 illustrates a vest 206 or any type of clothing that is equipped with an LED light sheet patch 208 for either safety or as a way to illuminate a wide area around the wearer. In another embodiment, the LEDs, conductor layers, and other features of the light sheet are printed directly on cloth or other textile to obviate the need for a separate substrate. The cloth may be part of clothing or be sewn to clothing. For example, the light sheet may be printed directly on the vest 206 material.

The LED light strips may also be formed to be very narrow to allow weaving of the strips to form a flexible fabric.

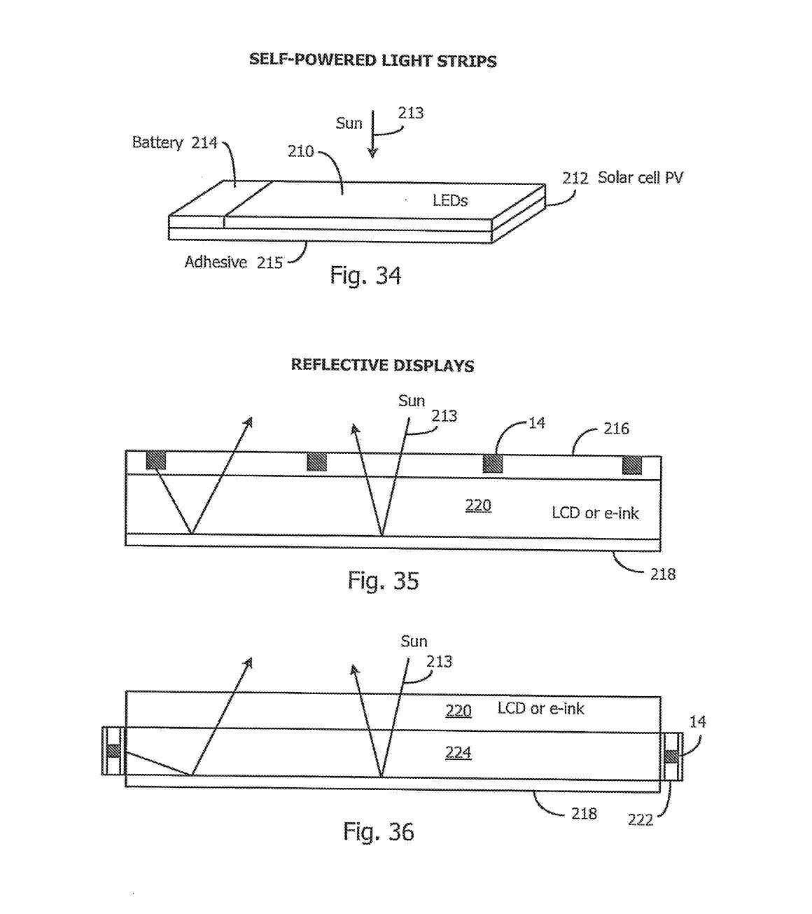

For certain outdoor applications where a source of power is not available or the replacement of batteries is not practical, the LED light sheet 210 of FIG. 34 may be connected to a photovoltaic cell 212 and a rechargeable battery 214. FIG. 34 illustrates a self-powered safety strip such as for walkways, emergency guides, identification of poles along roads, etc. The photovoltaic cell 212 comprises a thin layer of printed silicon diode beads sandwiched between two conductor layers, where the top conductor layer is transparent to allow the diodes to receive sunlight 213 and generate sufficient current during the day to fully recharge a printed lithium-ion battery 214. The LED light sheet 210 is transparent to allow the sunlight to reach the photovoltaic cell 212. Alternatively, the cell 212 may be laterally adjacent the light sheet 210. Since the light sheet 210, cell 212, and battery 214 all retain the same relative dimensions irrespective of the overall footprint, the same basic structure can have any size and operate in exactly the same way. An adhesive layer 215 on the bottom of the device allows the device to be affixed to any surface. The device may be on the order of about 1 mm thick.

The light sheet may also be formed to display a particular message, such as “caution” for road warnings and/or be formed to resemble traffic cones. By blinking the LEDs at intervals, the battery supply can last all night.

As shown in FIG. 35, since the basic LED light sheet can be transparent, the light sheet 216 can be used as a top layer in a reflective display. Areas of proximate red, green, and blue LEDs 14 may be used to create white light without the need of a phosphor layer. A reflective layer 218 is provided as a bottom layer. The light sheet 216 and reflective layer 218 sandwich a liquid crystal display (LCD) 220 effectively forming pixel light shutters. E-ink may be used instead. A conventional LCD controller controls the pixels to either block light or transmit light, or create grayscales, to display characters or animation. If sunlight is used, the sunlight passes through the transparent light sheet 216 and the “open” pixels and reflects off the reflective layer 218 to display the characters. If there is little ambient light, the LEDs 14 are turned on to emit light only in a downward direction to substitute for sunlight. The top electrode of the LEDs may be a mirror layer to block the LED light being directly emitted toward the viewer.

FIG. 36 illustrates another type of reflective display that enables the use of a translucent or opaque phosphor layer over the LED light strips 222 to create white light. When there is little ambient light, the LEDs 14 are turned on to inject white light from the sides of a transparent plastic waveguide 224. The top surface of the waveguide 224 is roughed to leak light uniformly out of the top surface to backlight the LCD 220 or e-ink layer. Sunlight can instead be used as described with respect to FIG. 35. The reflective displays of FIGS. 35 and 36 may be made about 1 mm thick. Better LED light mixing may be achieved with a thicker display.

Addressable LED displays are described below.

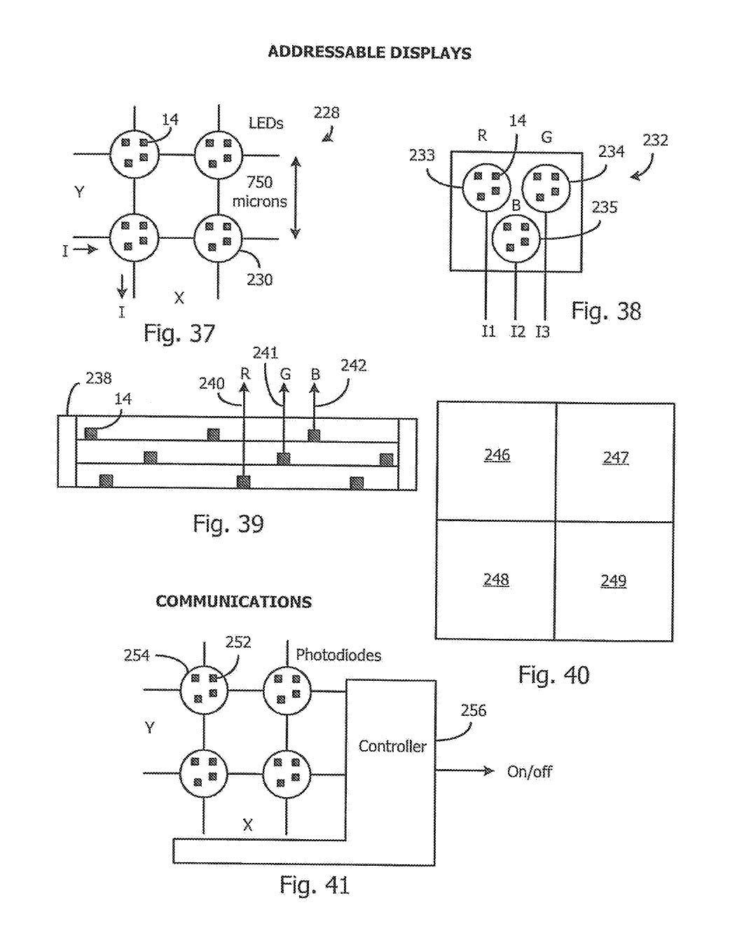

Although the printed microscopic LEDs 14 (FIG. 1) are randomly located, they are fairly uniformly distributed in the LED layer, and small pixel areas can be printed that have a very high probability of containing between 3-5 LEDs per pixel area. The pixel areas can be defined by screen printing or flexographic printing, among other possible methods. FIG. 37 illustrates a small portion of an addressable display 228 that has four pixels 230. Many more pixels are envisioned. Each pixel 230 has at least one LED 14 within it, and most likely has between 3-5 LEDs within it. For a monochromatic display, a YAG phosphor may be printed over each pixel 230 to create a well-defined white dot when the LEDs are illuminated. The LEDs 14 in each pixel 230 are sandwiched between two printed conductor layers, as described with respect to FIG. 1, where the top conductor layer is transparent. All LEDs in a column are printed over a column conductor strip (Y lines), and all LEDs in a row have their top electrodes contacted by a transparent row conductor strip (X lines). By selectively applying the anode voltage (e.g., 3 volts) and cathode voltage (e.g., ground) to the Y and X conductors, only the pixel at the intersection of energized conductors will be illuminated. At high scanning speeds, animation may be displayed. The pixels 230 may have a pitch of about 750 microns using screen printing.

If the current supplied to any pixel is fixed, an energized pixel provides the same brightness whether the pixel contains one LED or five LEDs. Therefore, such constant-current driving of pixels is ideally suited for a non-deterministic LED printing process.

The display can be bent into a partial cylinder to form a wrap-around immersion display.

FIG. 38 illustrates how a single pixel 232 can be formed of a red sub-pixel 233, a green sub-pixel 234, and a blue-sub-pixel 235, where the relative currents (IL 12, 13) to each sub-pixel define the overall color for that pixel. The LEDs 14 may be red, green, and blue LEDs. Alternatively, all the LEDs may be blue LEDs, and the red-sub-pixel 233 has a red phosphor printed over it, and the green-sub-pixel 234 has a green phosphor printed over it.

The red, green, and blue sub-pixels may be laterally displaced, as shown in FIG. 38, or the red, green, and blue sub-pixels may be vertically displaced as shown in FIG. 39. In FIG. 39, three LED layers are shown. Each layer outputs either red light, green light, or blue light using appropriate type printed microscopic LEDs. The LED layers are either laminated together, or the red, green, and blue LEDs may be successively printed, with a transparent conductor layer therebetween. In FIG. 39, an opaque wall 238 surrounds each pixel area to prevent lateral light creating noise in other pixels. The LEDs in each of the three layers are independently energized with a current to create the desired mixture of colors for the pixel. An X-Y addressing technique may be used for each color LED in each pixel. The RGB light (rays 240, 241, and 242) blends very well and there will be statistically little or no overlap of LEDs due to the microscopic size of each LED and the random distribution of LEDs. Any statistically calculated overlap of LEDs, creating some light blockage, may be compensated for by adjusting the density of LEDs in each layer.

A thin, flexible and light bracelet or other item of clothing can easily be created that displays a programmable animation or any other display.

FIG. 40 illustrates how a large addressable or static color display may be created by identical interconnected light sheets 246-249. The proper alignment of the light sheets 246-249 couples the column and row conductors together and aligns the pixels. Suitable connectors may be provided along the four edges of the light sheets 246-249. An adhesive or other structure may be used to affix the light sheets 246-249 together. There will be no visible interfaces, since the light sheets 246-249 are so thin, and the pixels may extend to the edges of the light sheets 246-249.

FIG. 41 illustrates how the basic structure of the light sheets can be used to detect light rather than generate light. Instead of printing vertical LEDs, vertical photodiodes 252 are printed and properly biased to conduct an analog current proportional to the light impinging on the photodiodes. This technique can be used to create an extremely inexpensive and thin camera for certain purposes, such as for roughly detecting images for user biometrics and for light or motion sensing applications. An optional lens may be positioned over the photodiode array. If imaging is desired, groups of the photodiodes 252 are printed in an array of independently sensed pixels 254. The photodiodes 252 are connected in parallel in each separate pixel 254, where the top conductor layer is transparent. A controller 256 scans the X and Y conductors to detect and process the analog current for each pixel 254 to determine the image or to control other circuits.

The LED light sheet may also be used for entertainment purposes such as described below.

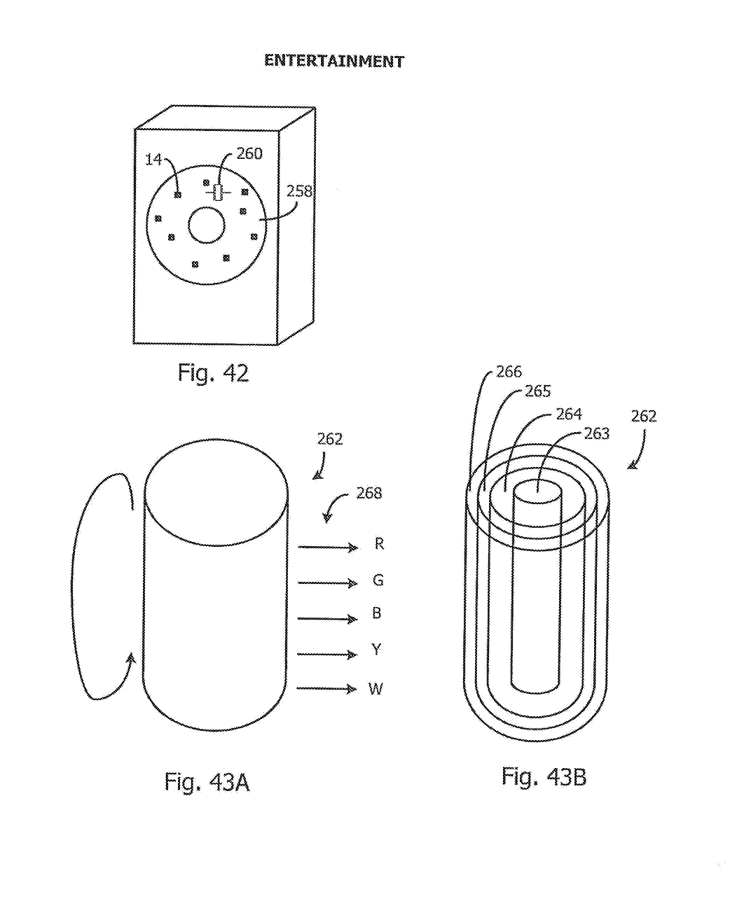

In FIG. 42, the cone of a woofer 258 in a speaker is laminated with an LED light sheet containing the LEDs 14. The light sheet is bent to form a cone. Red, green, and blue LEDs may be used to create a mixture of colors as described above. A piezoelectric element 260 generates a voltage having a magnitude and frequency that is related to the magnitude and frequency of the movement of the cone. The electrical signal may be used to directly drive the LEDs 14, or the signal may be processed and amplified to drive the LEDs 14 to create light patterns with varying colors and brightness that correspond to the music being played.

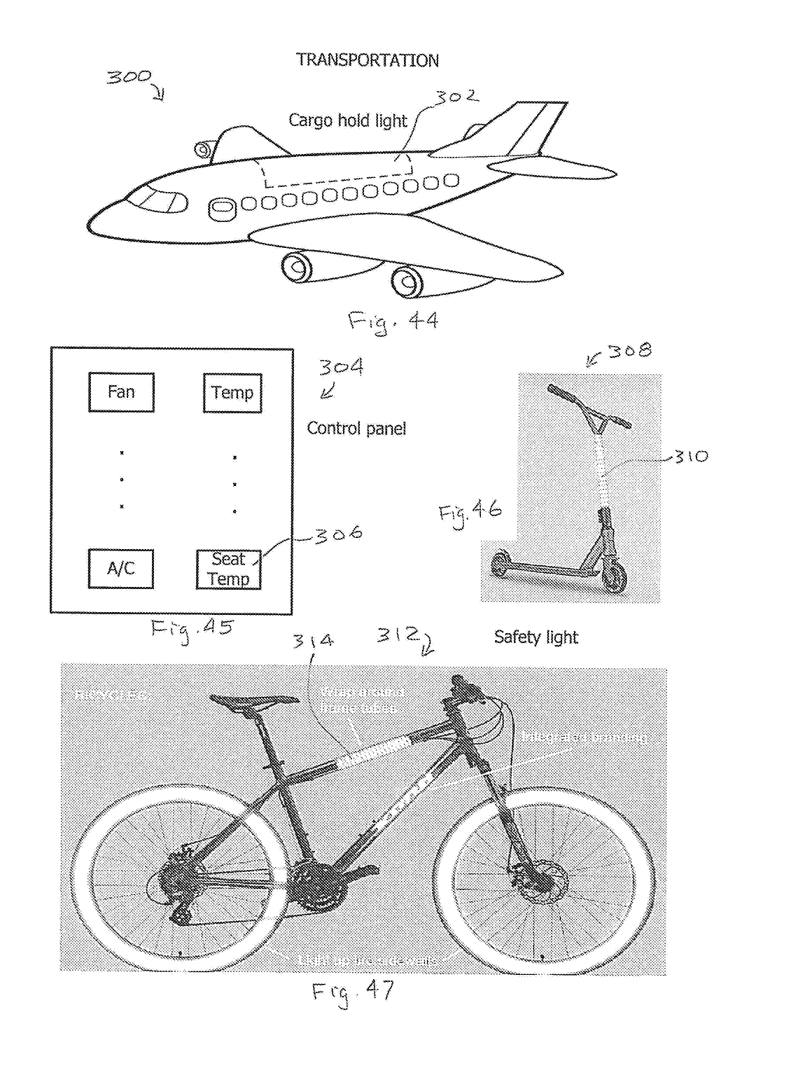

FIG. 43A is an external view of another light entertainment system 262, and FIG. 43B is a semi-transparent view of the system 262. A central column 263 of the system 262 is formed by a single light sheet containing blue LEDs, where the light sheet is rolled up to form a cylinder. All the blue light is emitted outward. As shown in FIG. 43B, there are three concentric transparent cylinders 264, 265, and 266 surrounding the central column 263, where the cylinder 264 contains a liquid with red phosphor particles, the cylinder 265 contains a liquid with green phosphor particles, and the cylinder 266 contains a liquid with any other type of phosphor, such as orange phosphor, yellow phosphor, or a combination of phosphors that create white light. Other types of phosphors may be contained in the various cylinders. The viscosity of the liquid is such that the phosphor particles slowly sink through the liquid when the system is turned upside down. The downward velocity of the various phosphor particles may be different for each cylinder so the colors change with time. Various color light rays 268 are shown in FIG. 43A. The system 262 may be inexpensively formed using transparent, flexible bent plastic sheets that are affixed between top and bottom circular plates. Reflective particles may also be included in the liquid. The phosphor particles may also be more randomly agitated by shaking the system 262 or by a heat source. The system 262 may be any size.

In another embodiment, only one cylinder surrounds the central column 263 and different types of phosphor are incorporated in the same liquid in the cylinder. The different phosphors sink at different rates or create random distribution patterns to change the overall color with time.

Additional applications of the basic light sheet include the following devices divided into market areas, some of which are elaborated on in the figures that follow. Most of the applications are self-explanatory.

### Market Areas

### Transportation

Planes
Cargo storage lights affixed to interior walls or fuselage. Can be flush to walls/ceilings. Such thin, flexible light sheets do not take up any cargo area, the light emission is wide and diffused, and the robust contoured light sheets are not prone to damage by cargo.
Fold down, or bend down, light from seat back above the sea tray. This light is closer to the passenger so there is less light that impinges on the neighboring passenger. The light angle is adjustable, and the thin light takes up very little space above the tray.
Taxi-way lights, or strips framing runways. Such light sheets are flat so can be anywhere on the runway. The light sheets can be dynamically controlled and/or shaped to provide indications.
Emergency direction lights
Instrument panel lights

Trains
Interior and exterior lights

Automobiles
Flat console control plate with backlit capacitive touch sensors and graphics. Circuitry can be printed and molded into the back of the console plate.
Translucent tires with integrated lights

Ships
Navigation lights
Dock lights

Bicycles
Snap on lighting for wheel guards, bicycle frames, or handle bars. Such a use is primarily for safety but the lights will also illuminate areas around the bicycle.
Attachable lighting to allow for directional indication, braking indication, or locational indication

Snowmobiles, ATVs, etc.
Similar safety and illumination lights as described for bicycles

### Entertainment

Music
Headphones with light built into ear cup, head band, microphone, and/or cord for indication, style, or illumination. Lights can be used to externally show the volume of the headphones for viewing by others and for parental control.

Theater
Stage lighting, such as for setting an overall mood of the stage, rather than point lighting to reduce glare for actors or theater goers
Display or light in theater curtains
Effects lighting

Photography
Umbrella light, where the light sheet directly lines a foldable parabolic light source, rather than using a reflective umbrella lighting source

Games
Gaming machines. Light strips can outline a gaming cabinet and dynamically controlled to reflect an outcome of a game or attract attention.
Smart game boards with programmable dynamic display. Board is able to sense a piece above it and react accordingly, depending on the game. Board can be a chess board, then become a Monopoly board.

Toys
Stuffed animals with integrated light patches and addressable displays. Bluetooth programming.
Blue sheet that can be drawn on by fluorescent pens for amusement or signs
Lego-style pieces that can pipe light from a light sheet support surface
Lego-style pieces that light up together and can be interconnected to create bigger light structures
Light integrated into flying drones for super lightweight and low power draw
Lighting integrated into toy cars/vehicles
Toy racing car tracks
Doll houses
Collapsible play scape
Pool floaties, noodles, or water wings
Pool lighting for increased safety
Jigsaw puzzles or construction type games with interconnecting pieces (having electrical connectors) that light up when properly assembled
Costumes visible in the dark, especially for safety

Sports
Golf
   Golf balls
   Golf clubs
   Golf bags
   Golf shoes
   Lit flag
   Lit hole
Football
   Footballs
   Football jerseys
   Football helmets
   Down markers
   Stadium
Soccer
   Soccer balls
   Soccer goals
   Soccer jerseys
Hockey
   Hockey pucks
   Hockey rinks
   Hockey goals
   Hockey sticks
Other
   Lacrosse sticks
   Lacrosse balls
   Paintball/lasertag
   Skis
   Ski poles
   Snowboards
   Skateboards
   Helmets
   Gun targets
   Lit arrows, especially in the fletching
   Frisbee
   Surfboards, potentially shark repellent
   Underwater curtain lights
   Fishing lures
   Scuba suit with light, for safety (person finding)
   Tent lights, especially tent wall

### Police/Military

Lights in tracer shells. LEDs can generate visible light or IR. Integrate capacitor/battery into light sheet.
Emergency road signs and police barriers

### Displays

Continuous display roll with selectable length by end user selecting/cutting/tearing strip
3D display made by many transparent planar sheets stacked with index matched material
Heads up display where transparent light sheet is laminated to windshield or visor, and LEDs are controlled to display pertinent information to driver

### Electronics

Consumer Electronics
Cellphone cases. External lights can be used to show battery life or incoming call.
Laptops cases
Desktops cases
Tablets cases
Addressable piano keyboards for teaching. Can match lit glove finger color to a corresponding lit key.

### Architectural

For building accent
Lit window sill
Lit window frame
Blinds such that the blind's orientation dictates the illumination of a room. Closed one way causes the light to be on, closed the other way causes the light to be off and blind blocks outside light.
Pillar highlights, wrap around lights
Doors and door frames lighting up
Lit wall sconces
Stair tread lighting
Stair railing lights, especially if shining downward to illuminate stair
Deck post lights
Molding, crown molding, wainscoting all lit
Fabric draping down with integrated lights, both directions
Lamps in glass bricks for walkways, shower, etc.
Transparent, two sided light that becomes privacy filter when on
Create starry night effect on ceilings
Retrofit any Edison-type lamp using lamp formed from light sheet

In building accent
Wall accents, especially curved surfaces
Ceiling accents
Floor accents
Wall or floor guide lights
Lit fan blades, lighting upwards, downwards or both
Apply to phone to illuminate buttons or when phone ringing
Apply to translucent shelves (as lightguides), such as in cabinets, refrigerator, etc., to light up objects on shelf
Apply as an adhesive strip near the front edge of shelves for illuminating objects on shelves

Stand-alone accent
Illuminated tiling, perhaps with electricity generation

Stand-alone lighting
Illuminated paths
Illuminated lanes
Illuminated bridge walls

### Appliances

Displays integrated into body of appliances
Night lights integrated into handles or surfaces for low level illumination
Light on the base of refrigerator or oven or other appliance for floor wash

### Advertising/Informational

Signs
Sign backlight that is ultra thin
Lit page (edge or direct lit) that can be printed on to customize lighting
Front lighting billboards with angled light
House number or owner's name in standardized frame for power, direct view
Street signs having visible letters during day which light up during night using photocell
Store aisle signs with addressable segments that focus attention on a product in aisle. Sign can be changed remotely.
Signs to automatically adjust font and font size based upon demographics
Realtor signs including standard graphic display portion and customizable lit display portion
Programmable street signs, emergency, road work, remotely programmed
Light sheet has surface that can be printed on using a standard black-ink laser or inkjet printer. Light sheet is inserted into paper tray of printer. User uses a home computer to create an opaque or color pattern for the light sheet to display any information.

Leaflets/promotional items
Business cards with printed battery
Magazine inserts
Flyers
Brochures
Leaflets
Lit pens or backlit logo on a pen
Lit bags, especially for logos
Translucent or porous 3D or 2D logo that is visible by day and backlit at night
Buttons, badges and nametags
ID badge that blinks if you enter an area you shouldn't be in

### Safety

Pets
Light up vests and collars for cats and dogs
Training and behavior lights
Pet clothing
Pet play structures
Cat trees with dynamic lighting for play

Personal
Vest, coat, jacket, etc. with built-in lighting for directional indication, braking indication, or locational awareness. Especially useful for motorcycles and bicycles. Perhaps powered by wire to bike or battery in vest. Wire could send commands on which area to light. Wearer's movement can also select which indicator light to illuminate.
Medicine bottle with label that lights up to indicate time to take medicine. Programmable light timer could be reset based upon last opening or last movement of bottle.

Professional
Safety vests
Guard rails with integrated lights

### Textile

Apparel
Gloves for safety and illumination
Shoes with light up sole, tongue, side, back, or toe
Shoes with blue LEDs, taking advantage of the ‘starry night’ effect to sparkle while walking
Logos, shapes, symbols, pictures, text, and/or designs lighting up on shirts, pants, ties, hats, watches, coats, scarves, ascots, belts, dresses, skirts, shorts, and/or underwear. The light can be integrated into, onto, or behind the fabric.
UV LEDs in pillows to sanitize pillows after use
Light sheet on backpacks for safety and illumination while camping
Weight sensor in luggage with integrated light to indicate excessive weight for air travel
Illuminated cap brim for task lighting. Light angled away from face using Fresnel lens.
Pocket, purse lights. Light sheet on inside wall.

Upholstery
Bedding. A weavable thread may contain LEDs and conductors.
Chairs
Couches
Foot rests

Carpeting
Light beneath carpeting using fibers to act as light pipes

Miscellaneous
Pull down sun shade/light
Fabric with strips of lamps woven into

### Medical

Surgery illumination internal to patient and external

Hospital
Low glare lighting for patient rooms

Dental illumination and UV curing light

Diagnostic
MRI interior

Treatment
Patches for Acne, Psoriasis, Eczema, Vitiligo, Itching, Cutaneous T-cell lymphoma

First Responder emergency lights

Embedded into HVAC with UV lighting for killing bacteria

### General Lighting

Emergency/Humanitarian
UV LED light sheet wrapped around clear pipe for sanitization
Emergency shelters with integrated flat lights
Pop-up shelters with integrated flat lights
Portable/Temporary runway lights
Compact emergency lights, drop from planes
Blue exit signs for some situations where red is less preferable for visibility
Drop lights, self-contained with battery
Hazard/warning/crime scene tape with integrated light

Home/Garden/Dining
Lights printed and built into the form of living plants. Incorporate batteries and solar panels to have a fully integrated plant light system.
Holiday ornamentation. Lights can be cut and molded into plastic. Can be made to fit existing “Christmas light” strings.
Chairs, especially large chairs, with lights built into underside to illuminate floor area
Aquarium Lights
Grow lights. Vertical sheets may be inserted into the liquid medium to maximize surface area.
Lit street address, especially for night time visibility
Bricks with lamp on side, PV on top, and battery in middle
Lighting stairs
Lighting mortar between paving stones
Dividers in sidewalks/driveways
Lit outlet covers
Railings on stairs lighting up, illuminating areas below/around it
Within cabinet lighting
Drawer lights shining towards contents
Toilet seat with integrated light
Light under overhang in bathrooms/kitchens to light floor
Light behind tiles especially for sinks/tubs
Light water from faucet/shower, perhaps to show temperature
Lighting around vanity
Light on toothbrush
Wallcoverings

Retail/Office/Industrial
Pathfinding lighting, especially shaped into arrows to direct
Bioreactor
Cleanable lights for food service
Lights that don't cause spoilage like fluorescent, and don't have glare like traditional LEDs and no point sources of heat
Borders of displays
Optimized wine and jewelry displays
Customized spectral power distribution for different product areas

Utility
Insertable lighting for mechanics
Light switch plate with integrated light
Foldable light for ease of travel with larger light
Goodyear blimp lights.
Lights supported by a helium balloon with solar and battery integrated. Usable indoor or outdoor, no need for stands.

Various examples are illustrated in the figures.

FIG. 44 illustrates an airplane 300 with an interior light 302 formed from the flexible light sheets. Since the light sheets are very thin, there is less chance of damage from cargo, and the light emission is very wide. The light sheet may be used on any wall of the plane, including exterior walls for signage and safety.

FIG. 45 illustrates a very thin and flexible control console 304 that may be used in any vehicle. A front graphics sheet displays the location of touch screen control buttons 306. Behind the graphics sheet is a thin capacitive touch sensor layer that detects the XY position of any touch. A backlight or an edge-lit waveguide may include the LED light sheet, where the graphics sheet creates light openings for the light so the user can see the button labels at night. The touch sensor and any other circuitry may be directly printed on the light sheet or the graphics sheet. Alternatively, the touch sensor may be conventional. A processor (not shown) is coupled to the touch sensor for converting the touched XY position to the appropriate electrical signals for carrying out the selected function. The entire thickness of the console 304 may be on the order of 1 mm or less and may simply be affixed over a solid surface.

FIG. 46 illustrates a scooter 308 with a light sheet 310 wrapped around the post for safety and providing illumination.

FIG. 47 illustrates a bicycle 312 with a light sheet 314 wrapped around any portion of the frame for safety and providing illumination. The lit frame conveys to a driver that the object is a bicycle. The logo and tires may also be illuminated.

FIG. 48 illustrates a rubber tire 316 that is formed of a translucent material. A light sheet or strip in the hub 318 illuminates the tire for safety or for adornment.

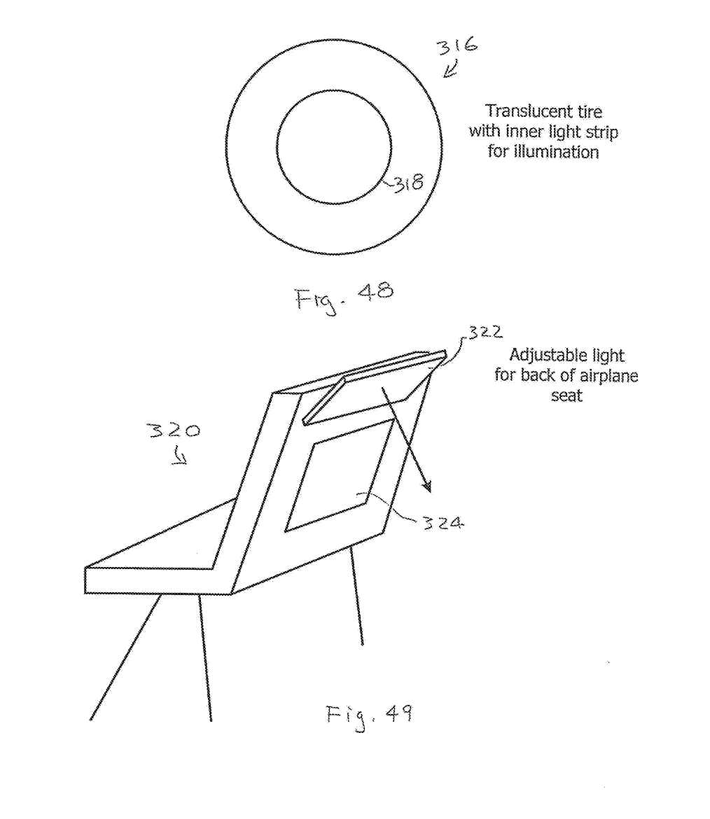

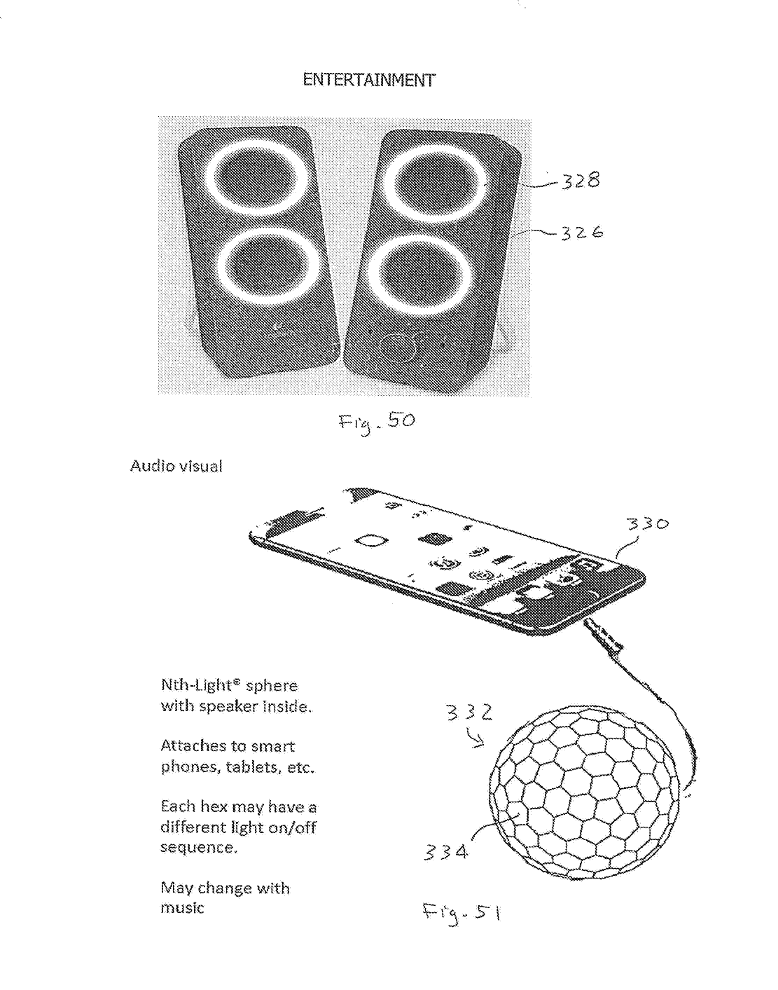

FIG. 49 illustrates the back of an airplane seat 320. A fold-up or down light sheet 322 is provided above the standard tray 324 for use by the passenger for reading. Since the light is not the conventional overhead point source, there is less shadow and the light is more uniform. A Fresnel lens or brightness enhancement filter (a thin laminated layer) may be used to limit the side light and enhance the front light.

FIG. 50 illustrates speaker enclosures 326 with light strips 328 mounted around the speakers. The light strip's energization current may correspond to the volume or frequency of the music for an entertaining effect or may be controllable by the user.

FIG. 51 illustrates a conventional programmable smartphone 330 having an I/O port, which may be a USB port or a headphone jack. An app downloaded into the phone via the internet controls the light emitted by a light sphere 332 (or any other shape) based on any programmed parameter, such as music. The sphere 332 may have hexagonal light sections 334, where the sections may be individually controlled, such as by music or in a programmed sequence. The sphere 332 may even act as a speaker. The sphere 332 may plug into any other type of device and maybe remotely controlled such as by a Bluetooth connection. The power for the LEDs may be generated by the smartphone itself or by a power pack inside the sphere 332.

FIG. 52 illustrates a cover 336 for a smartphone, where light sheet sections 338 are in the cover 336 and are controlled either by the smartphone or independently of the smartphone. For example, the light sheet sections 338 may be illuminated in response to a vibration of the smartphone, indicating that there is an incoming call. Or, the light sheet sections 338 may indicate a battery level of the smartphone. The function may be programmable. The light sheet sections 338 may also provide an addressable display to display any information. The power for the light sheet sections 338 may be provided by the smartphone or by a power pack in the cover 336.

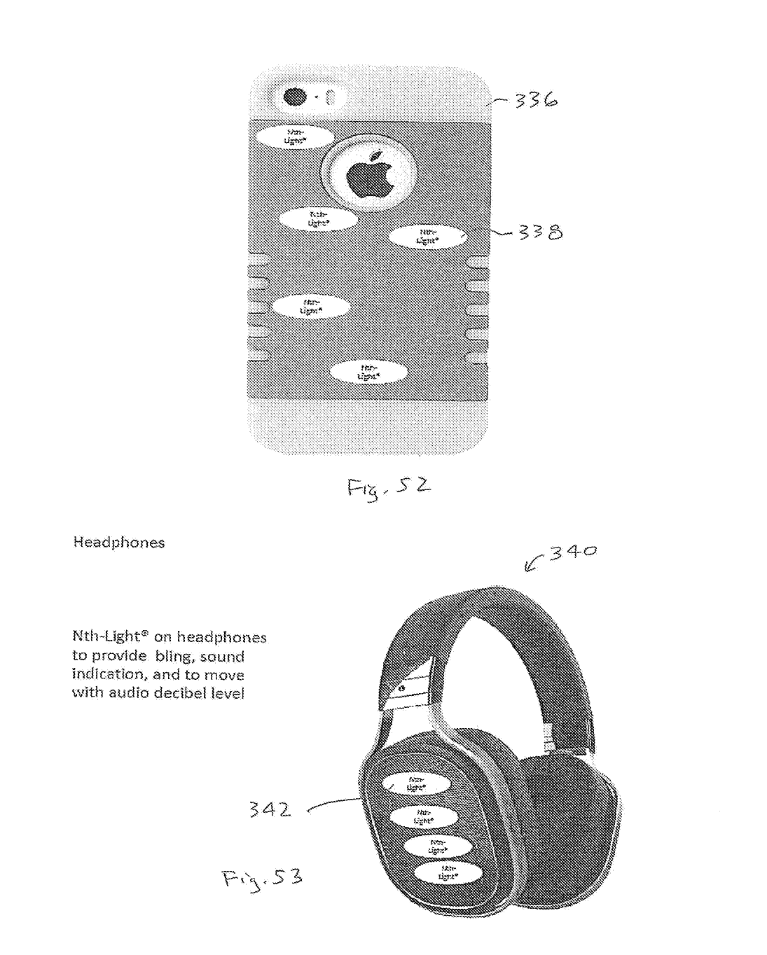

FIG. 53 illustrates headphones 340 with external lights 342 that can be used for indicating the headphone volume, such as for parental control, or for purely visual effects. The volume may be indicated by how many light segments are lit.

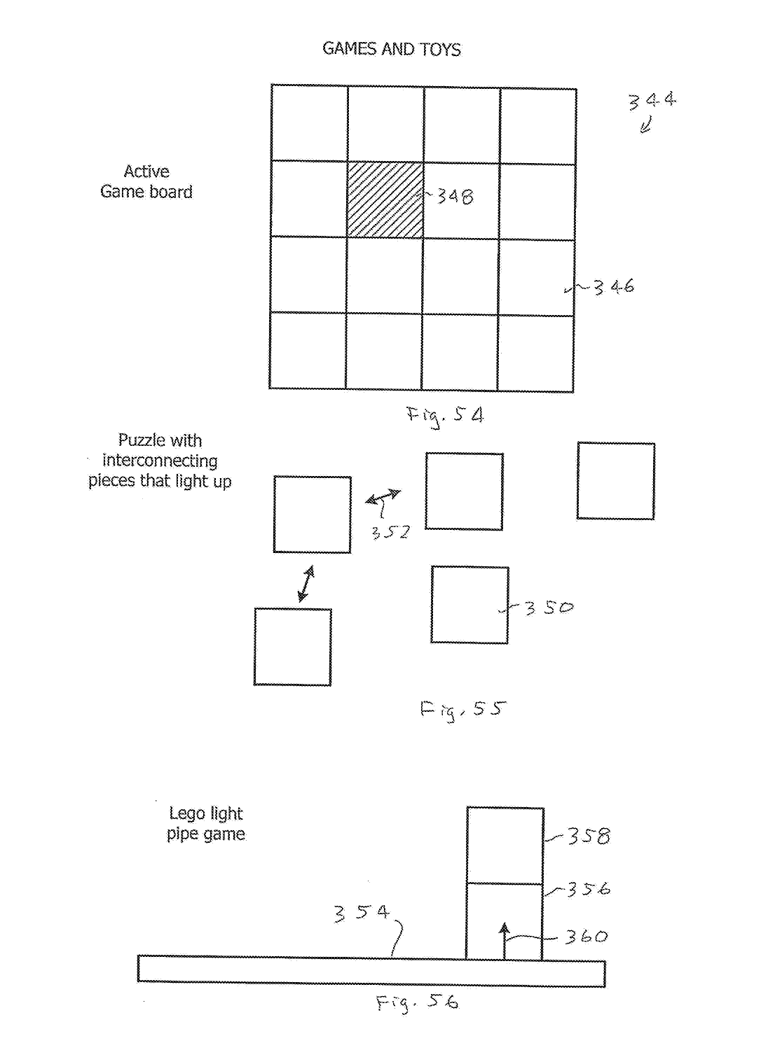

FIG. 54 illustrates how the light sheet may be incorporated into a game board 344. In the example, the game board 344 is an addressable display that is segmented in squares 346 or any other units suitable for a particular game. The squares 346 may be selectively illuminated (such as square 348) by any means, such as by downward pressure or by a processor carrying out a game routine. The game itself may be to illuminate squares in a certain pattern, where a square remains lit until reset.

The game board 344 may also represent a universal game board where the pattern of the board depends on the particular game entered into a processor controlling the addressable display. For example, the same game board may act as a chess/checker board, a backgammon board, or a Monopoly-type board.

FIG. 55 illustrates light segment pieces 350 of any shape. The pieces 350 have electrical connectors. At least one piece 350 must be connected to a power source. When the pieces 350 are properly connected, all the pieces 350 light up to illustrate that the player has won the game. The arrows 352 illustrate the proper connections between certain pieces 350. The game may be to connect the pieces 350 between a start port and a finish port, or the game may be to connect the pieces 350 in a certain pattern like a puzzle.

FIG. 56 illustrates how the lighted game board 354 is adapted to allow players to place interconnecting pieces, such as pieces 356 and 358, on it so the light 360 is channeled through the pieces. The pieces act as light guides. The pieces may resemble Legos™. Each piece may output the light, or only selected pieces may output the light. The game may entail creating a certain light pattern, or the player wins the game when a certain piece emits light.

FIG. 57 illustrates how the light sheet may be mounted in or on any type of object, such as a skateboard 362, to highlight the logo. In the example, the light sheet 364 is formed in the shape of the logo SKATE. Alternatively, a graphic may selectively obscure the light to form the logo.

FIG. 58 illustrates how the light sheet 366 may be laminated on the tips of skis 368 to illuminate the snow in front of the skis 368 for better visibility. In flat light conditions, it is difficult to see snow features, due to the lack of shadows, and skiing becomes more dangerous. With the ground level light emission from the tips of the skis 368 in an optimal color, such as yellow, the snow features are better seen.

FIG. 59 illustrates how the thin and flexible light sheets may have a target pattern 370 printed on them for forming lit targets for archery and gunnery. Since the LEDs are connected in parallel, holes will not affect the undamaged LEDs. The lit targets provide better visibility of the target, and after shooting, the lit target provides better feedback of the positions of the arrows and bullet holes.

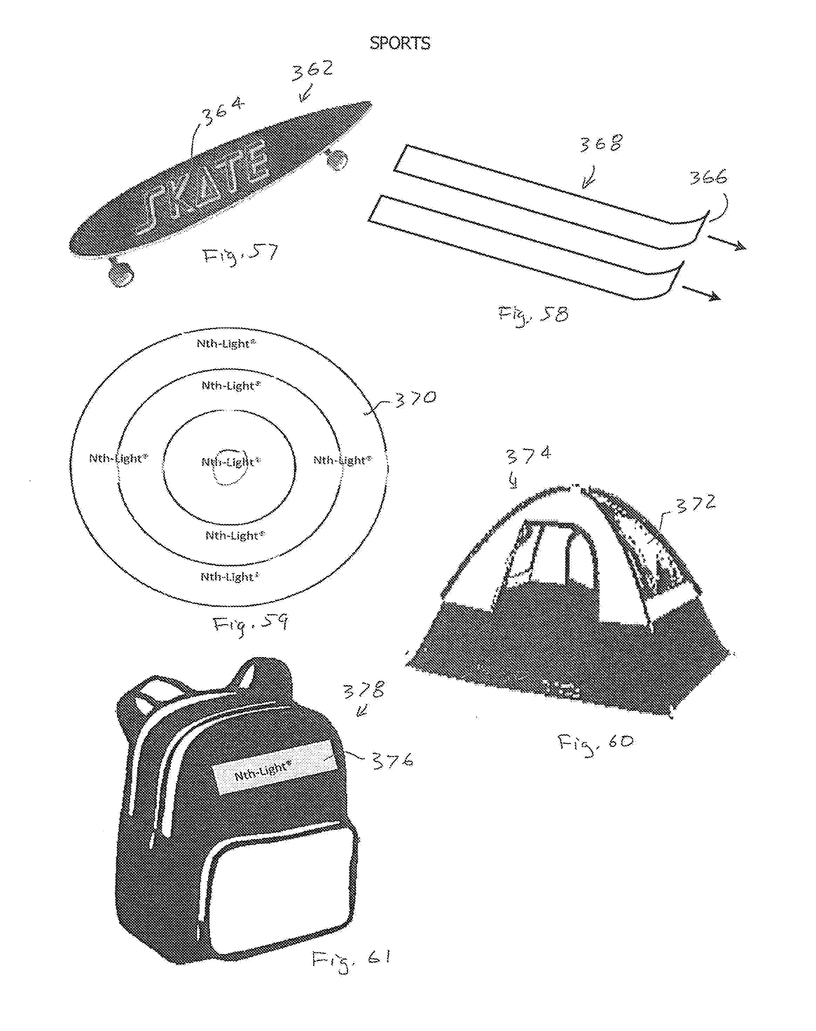

FIG. 60 illustrates how the thin and flexible light sheets 372 may form part of a camping tent wall for illuminating the inside of the tent 374 yet allow the tent 374 to be folded up. The light sheets 372 are sealed and waterproof.

Light sheets may also form part of a sleeping bag.

FIG. 61 illustrates the light sheet 376 on a backpack 378 for safety and illumination. The light sheet 376 may be bi-directional and illuminate the contents of the backpack 378, which is especially useful during camping.

FIG. 62 illustrates how the rugged light sheet 380 may form part of a projectile 382 and emit light after firing to allow a user to visibly track the path of the projectile. The LEDs may instead be infrared to allow the projectile to be tracked without being visible to the naked eye. The light sheet 380 can withstand thousands of Gs and still properly operate. A flat capacitor may be used to briefly power the light sheet 380 during flight.

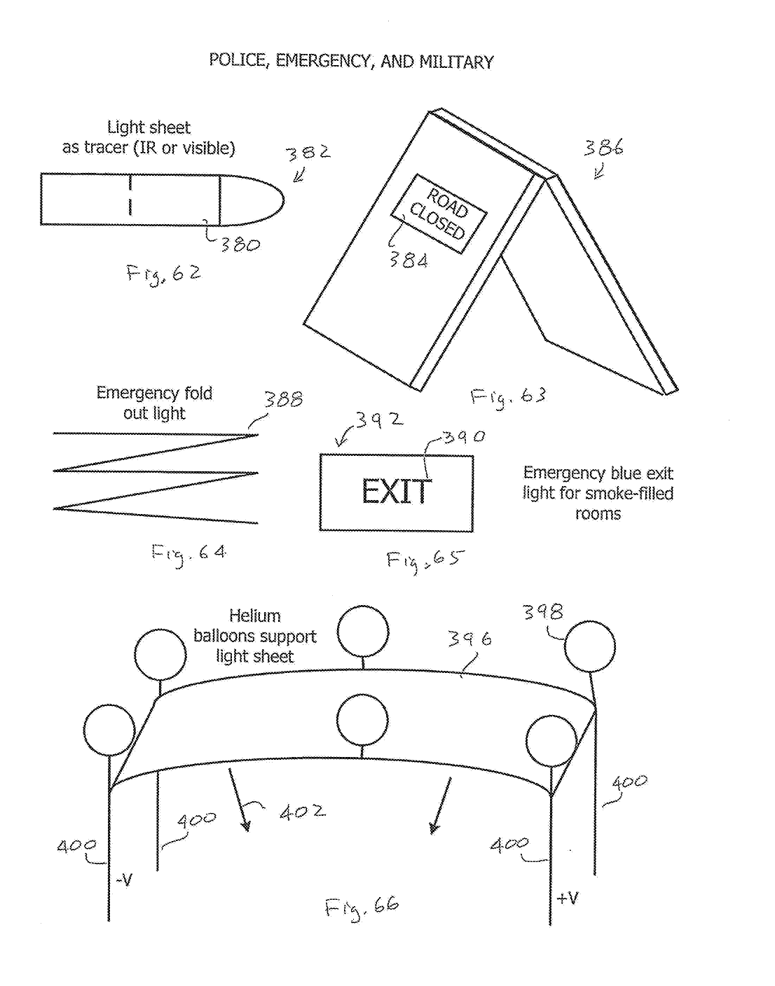

FIG. 63 illustrates how the light sheet 384 may form an addressable display on a folding emergency road sign 386. In another embodiment, the light sheet 384 is not programmable and backlights a graphic (with an opaque reverse alphanumeric image), and all suitable graphic sheets are supplied in a pouch on the other side of the road sign 386 for selection by the workman.

FIG. 64 is a side view of a light sheet 388 that is folded like an accordion for compactness. When the light is needed, any amount of the light sheet 388 is folded out. Suitable connectors or sensors may be used so that only the exposed light sheet segments are energized by a power pack.

FIG. 65 illustrates a light sheet 390 emitting blue light that is used as an emergency exit sign 392. During normal operation, the exit sign 392 is illuminated using a red backlight or by direct red light so that the light is subdued to not be intrusive. However, such red light is difficult to see in smoke-filled or particle-filled air such as during a disaster. In such an emergency, an additional blue exit light is energized, such as triggered by the affected air tripping a photocell, which can be better seen through the smoke-filled or particle-filled air. The blue light may replace the red light or outline the word exit.

FIG. 66 illustrates how the light-weight and flexible light sheet 396 can be unfolded and used to create a large elevated light source for any purpose. Helium-filled balloons 398 keep the light sheet 396 at any height, and the position and height of the light sheet 396 are determined by thin conductive wire supports 400. The wire supports 400 provide the energization voltage across the light sheet 396. Light rays 402 are shown.

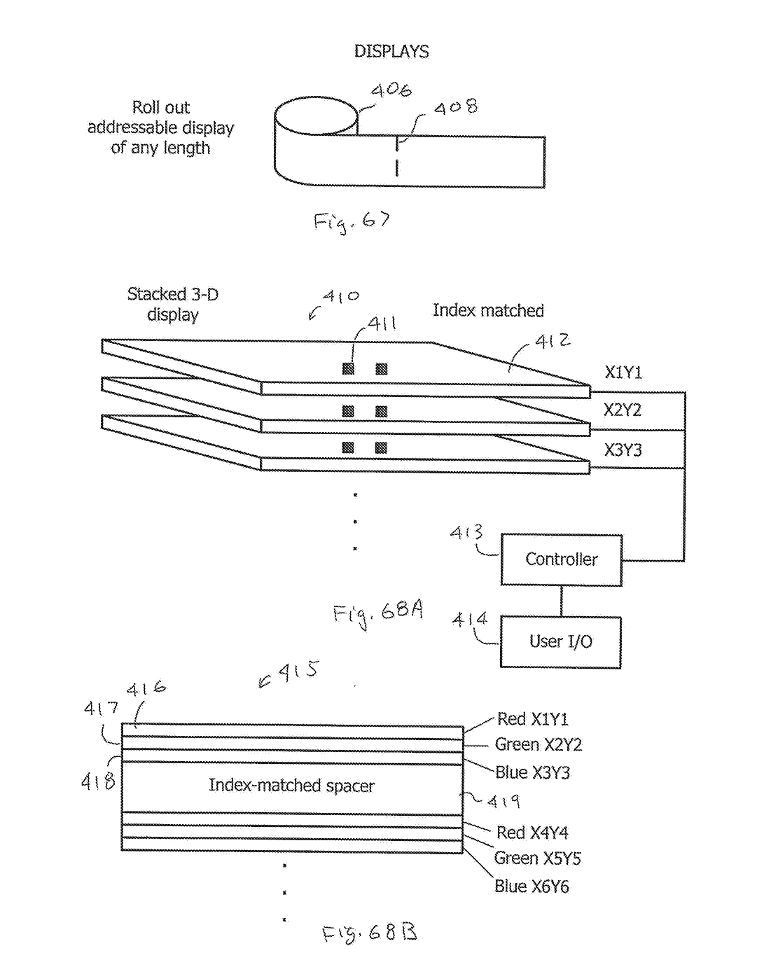

FIG. 67 illustrates how a very long light strip 404 is initially supported on a roll 406. Any length light strip can be cut from the roll 406 along indicated cut lines 408. The light strip has connectors or connection pads at each cut line 408 area that serve as the anode and cathode leads for all the LEDs on the roll 406. Alligator clips or other connectors may connect to the leads at both ends of the cut strip to illuminate all the LEDs in parallel along the strip.

In one embodiment, the LEDs along the strip are separately addressable and the connectors at the end of a strip provide X and Y leads to the LEDs along the strip. The leads can be addressed to create any type of alphanumeric display along the strip. The display can be static or dynamic.

FIG. 68A illustrates a 3-D display 410, where LEDs 411 are illuminated along the X, Y, and Z directions like pixels. Although only two LEDs 411 per light sheet 412 are shown for simplicity, there may be thousands of addressable LED pixels in each light sheet 412. Even though the individual printed LEDs are generally randomly located as a result of the LED ink printing process, an ordered array of individually addressable groups of LEDs (e.g., 2-3 LEDs per group) may be printed, where each group is a pixel. X and Y conductors may be connected to each group so that any pixel on a light sheet 412 can be individually addressed by providing the proper voltage across addressed X and Y conductors to illuminate the pixel at the intersection of the energized XY conductors.

The pixels may all be blue so that no phosphor is needed and the light sheets 412 are substantially transparent. The XY conductors may be formed by a transparent conductor.

Each light sheet 412 may be about 1 mil thick, so transparent spacer layers may be needed between the light sheets 412 to cause the XY pixel pitch to be about the same as the Z pixel pitch. The spacer material should be the same index of refraction as the light sheets 412 to minimize internal reflection. Alternatively, the lights sheets 412 may be supported around their perimeter to obviate the need for a spacer.

A controller 413 supplies different X and Y address signals to each light sheet 412 in the stack to create a desired 3-D arrangement of illuminated pixels. The pixels in the transparent light sheets 412 emit light in all directions, so the 3-D display 410 can be rotated to see all aspects of the 3-D image. The display 410 is ideally formed as a cube so that the visibility is about the same when viewing all sides. In one embodiment, the cube is about 4 inches per side.

The 3-D image may be programmed by a user I/O interface 414. In one embodiment, the 3-D image is an object that has been created using a CAD application, and the 3-D image produced enables the user to better grasp the 3-D design. The 3-D image may also be from a 3-D camera or any other source. The 3-D image may be static or be animated. In one embodiment, each light sheet 412 has about 10,000 addressable pixels (100×100), and there are 100 stacked light sheets 412 so there are 100 pixels in each of the X, Y, and Z directions. Any other size and resolution can be made using a printing process.

FIG. 68B illustrates a full color 3-D display 415, which may be formed as a cube. Each horizontal level of full-color pixels is formed by red, green, and blue pixels provided in separate and abutting light sheets 416, 417, and 418, respectively. The red, green, and blue LEDs associated with a particular pixel location may be simultaneously energized by application of an appropriate current at the XY intersection of the pixel for each of the light sheets. Each light sheet is transparent since no phosphor coating is needed. An index-matched spacer sheet 419 is shown, which may be the same material as the light sheet substrate (e.g., PET, PMMA, etc.)

Given the nature of the structure, the 3-D image is primarily viewable through the top and bottom surfaces of the cube. Accordingly, the side surfaces may be coated with a light absorbing material.

In another embodiment, concentric spheres of the light sheets may form pixel layers in a spherical 3-D display. In such a case, the 3-D image may be viewable from any angle. Concentric shells of the LED layers and other layers may printed or sprayed over a starting sphere substrate. All conductors may be terminated at one area of the sphere for the XYZ signals.

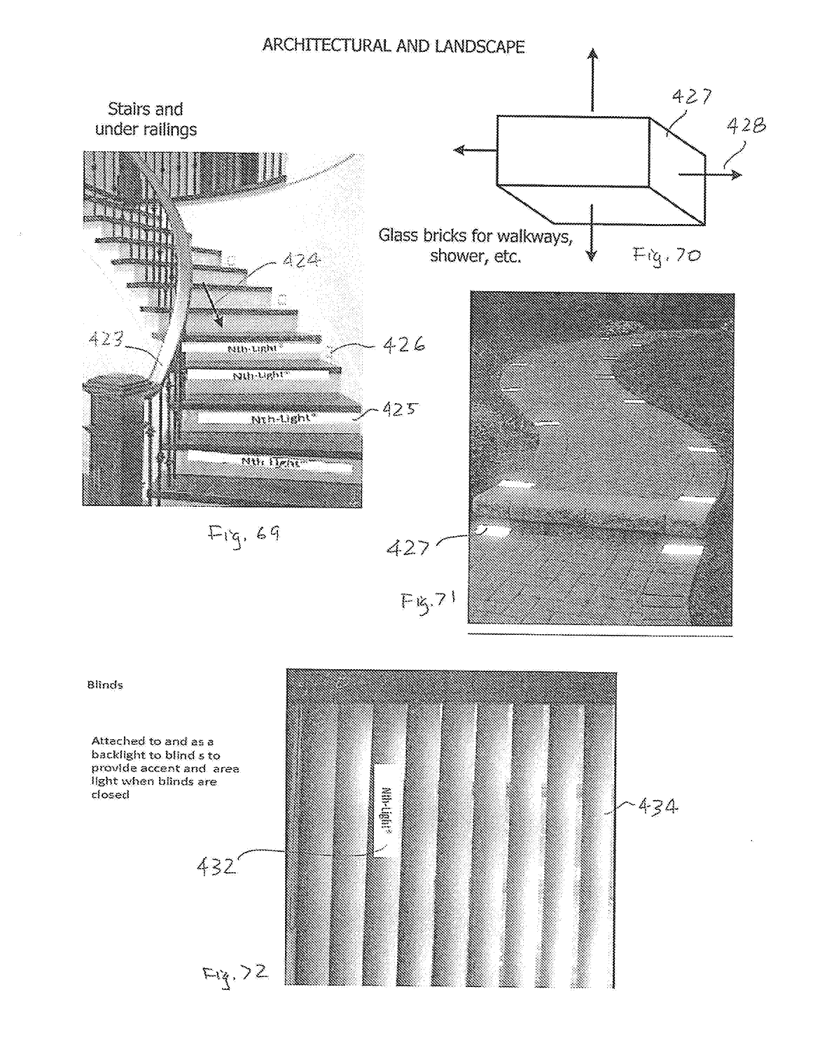

FIG. 69 illustrates how light strips may be attached under stair railings 423 to illuminate stairs for safety or aesthetics. A light ray 424 is shown. Further, each step may be illuminated by a horizontal light strip 425. Low wall lights 426 may further illuminate the stairs.

FIG. 70 illustrates a light-emitting construction block 427 that contains a light sheet, such as along a top wall or along any of the walls. At least one wall is translucent to allow light to escape. Other walls may be reflective. Light rays 428 are shown. The block 427 may be any size such as for use in a shower or walkway. The block 427 may thus provide mechanical strength to a structure while emitting light.

FIG. 71 illustrates the use of the light emitting blocks 427 substituting for conventional bricks along a path. The blocks 427 have the same dimensions as conventional bricks. The blocks 427 guide the walker and are aesthetically pleasing. The top of the blocks 427 is translucent and the remaining walls of the blocks 427 are reflective. The blocks 427 may be interconnected by a continuous wire that runs along each side of the path or under the path. The blocks 427 may have their light emitting walls positioned vertically when used in a step.

FIG. 72 illustrates the light strip 432 being laminated on vertical slats of blinds 434. Any number of the slats may include a light strip 432. The light strips 432 can be energized to create a vertical light wall at night. The angle of the light can be selected by angling the slats. The light strips 432 may be automatically turned on by angling the slats toward the room.

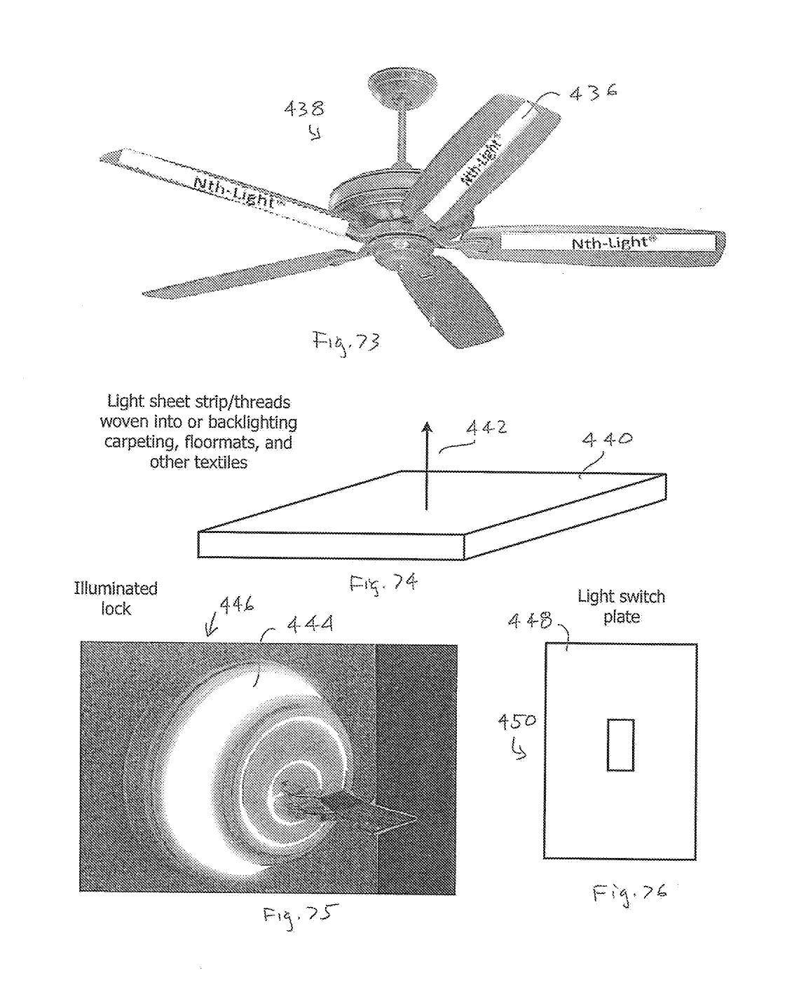

FIG. 73 illustrates how the light sheets 436 can be adhesively affixed to fan blades of an overhead fan 438. A brush conductor may rotate with the blades to provide power to the light sheets 436.

FIG. 74 generally illustrates how a light sheet or light threads may illuminate a carpet 440 or any other textile so that the carpet 440 is a light source. A light ray 442 is shown. The illustration represents any form of translucent object, including floor mats and curtains. If the LEDs and conductors are supported on a narrow thread, the threads may be woven into any structure. Many common carpets use polyester threads that act as leaky light guide loops, and such threads may optically couple light supplied under the carpet.

FIG. 75 illustrates a circular light strip 444 (or other shape of the light sheet) illuminating a lock 446 so it is easier to locate the lock 446 in the dark.

FIG. 76 illustrates the light sheet 448 backlighting a translucent light switch plate 450. The LEDs may be energized by the AC voltage present in the light switch box in the same way that some light switches are illuminated by the wires within the box. The anode and cathode leads of the light sheet 448 may be connected across the switch leads so that an AC current flows through the LEDs and the load when the switch is off. When the light switch is turned on, the LEDs are short circuited and turn off. If the LEDs are all in the same orientation, they will only turn on when the AC current is of the correct polarity.

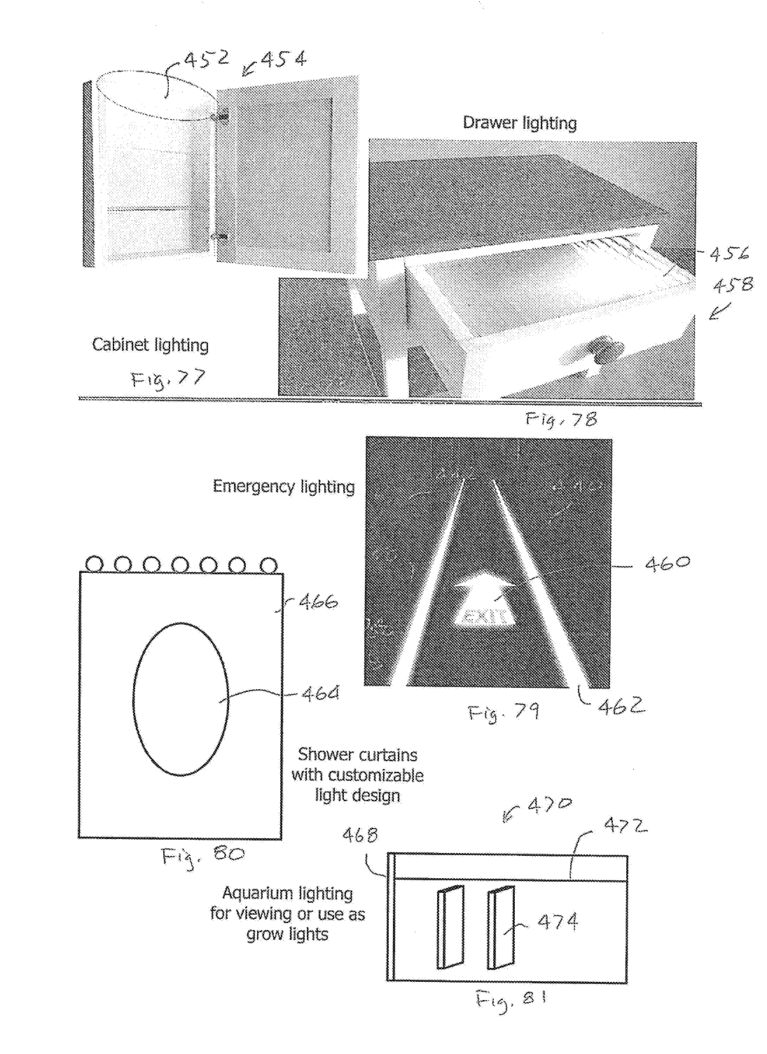

FIG. 77 illustrates a light strip 452 along a wall of a cabinet 454.

FIG. 78 illustrates a light strip 456 along a wall of a drawer 458.

FIG. 79 illustrates a shaped light sheet 460 providing a directional arrow in any building (or even along an airport runway) in the event of an emergency to point out an exit direction. Borders 462 of a pathway are also illuminated.

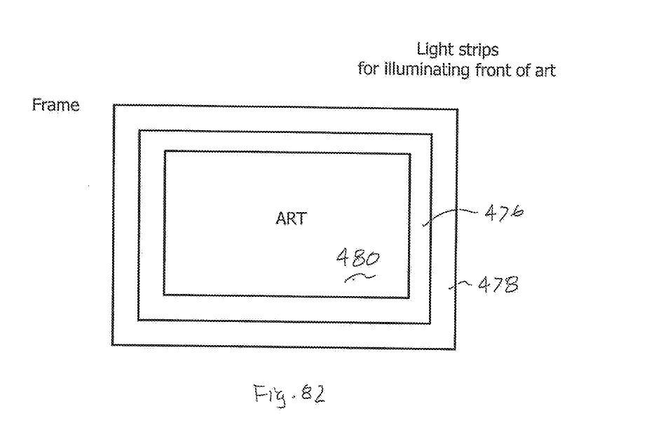

FIG. 80 illustrates the flexible light sheet 464 being part of a translucent shower curtain 466. The light sheet 464 can be in any shape.

FIG. 81 illustrates how the light sheet 468 can be along a wall in an aquarium 470 for illuminating the aquarium 470. The water line 472 is shown.

The aquarium 470 can instead be a vehicle for growing algae or other plants. In such a case, the light sheets 474 can be used as grow lights. To add more light emitting surface area, any number of light sheets 474 are vertically positioned in the water. The particular LEDs used are those optimal for growing the plants.

FIG. 82 illustrates how the light sheet or light strips 476 are mounted in a frame 478 for illuminating a picture 480. The light strips may be angled toward the picture 480. If the picture 480 is translucent, the light sheet may backlight the picture 480. The picture 480 may be a large billboard or a small photograph.

FIG. 83 illustrates how the light sheet 482 may be positioned within the air vent of a refrigerator 484, or placed near the bottom of any appliance, for illuminating the floor. Light strips may be placed behind handles 486 to locate handles in the dark. A display 488 on the refrigerator 484 using the light sheet may display any desired information.

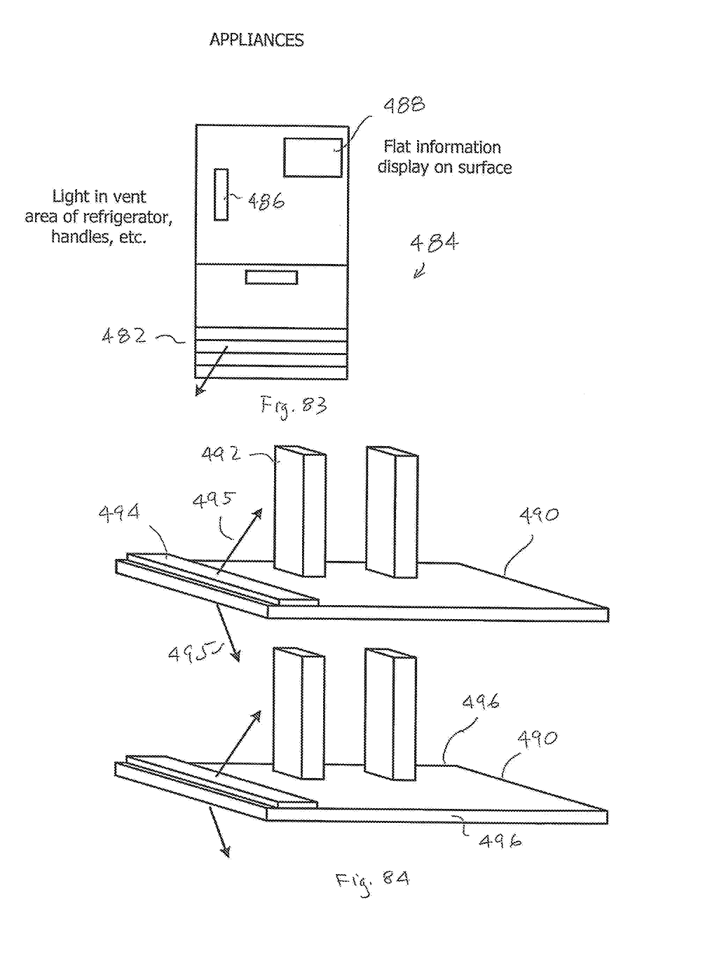

FIG. 84 illustrates shelves 490 for supporting objects 492. The shelves 490 may be within a refrigerated display at a supermarket and support food items. A light strip 494 is mounted (such as adhesively) near the front edge of each shelf 490 on the top and bottom of the shelf 490. A Fresnel lens may be use to direct the light toward the front of the objects 492 in the front row. The light strip 494 on the top surface illuminates the fronts of the objects 492 on the shelf 490, and the light strip 494 on the bottom of the shelf 490 illuminates the objects 492 on the shelf below it. In this way, the objects 492 are uniformly illuminated despite the heights of the objects 492. Light rays 495 are shown. Power to the LED may be via side conductors 496 on the shelves 490 being coupled to power buses on the inside walls of the refrigerated display. The power buses are part of the frame that supports the shelves 490. Many types of power connectors are contemplated, such as flexible metal brushes on the shelves that contact horizontal metal strips in the support frame, or a plug-in connector that connects when the shelves are fully inserted into the frame.

In an alternative embodiment, the shelves 490 are transparent glass or plastic and act as light guides. A light strip is affixed to one or more edges of the shelf to couple light into the shelf. The front edge area is roughened or has prisms formed in it to leak light to illuminate objects on and below the shelf.

FIG. 85 illustrates light sheets 500 forming or backlighting letters on street signs 502. When it is dark, the LEDs may be powered by capacitors charged by solar cells. When there is no power to the LEDs, the street signs are still visible in sunlight. For example, the street sign letters may be a translucent white in the off state. When the LEDs are on, the light backlights the letters so that they are illuminated.

FIG. 86 illustrates a realtor sign 504 that includes printed graphics 506 and an addressable display 508 displaying customized information, such as open house times, etc. The display 508 may be dynamic or static and programmed using a laptop computer or other means. Power may be supplied by a battery pack or by a capacitor charged by solar cells.

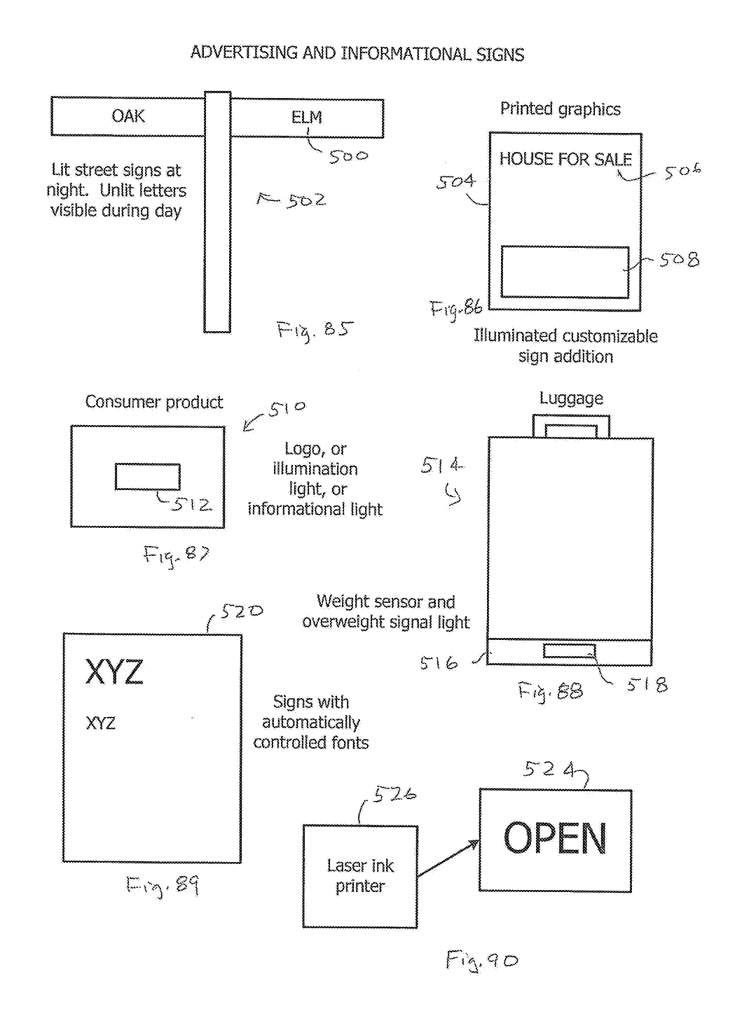

FIG. 87 illustrates any consumer product 510 containing a light sheet section 512 that forms a logo or backlights a logo. Any other information may be displayed. Since the lifetime of the light sheet typically outlasts that of the product 510, the light sheet may be permanently mounted or molded into the housing of the product 510.

FIG. 88 illustrates luggage 514 having a weight sensor 516, such as a piezoelectric element. When the weight is above the typically maximum weight for baggage in air travel (e.g., over 50 pounds), a warning light 518 is illuminated.

FIG. 89 illustrates a dynamic sign 520 using the light sheet connected as an addressable display. Based on the demographics of the viewers, the font of the sign is adjusted, such as enlarging the font for older viewers. The control of the font may be automatic, such as control based on the time of day.

FIG. 90 illustrates the light sheet 524 being used as a readily customizable illuminated sign. The light emitting surface of the light sheet 524 is formed of a plastic that adheres well to the inks used in conventional laser printers or inkjet printers. The light sheet 524 may be supplied as an A4 size or 8½×11 inch rectangle to emulate a sheet of paper. The light sheet 524 may be as thick and flexible as a sheet of standard paper and is placed in the paper input tray of a standard ink printer 526. The user then uses her standard printing application on her home computer to form an opaque (black) or color ink pattern that lets the light escape in the desired pattern and color. The ink is then printed on the light sheet 524 by the standard printer, and the customized light pattern is generated.

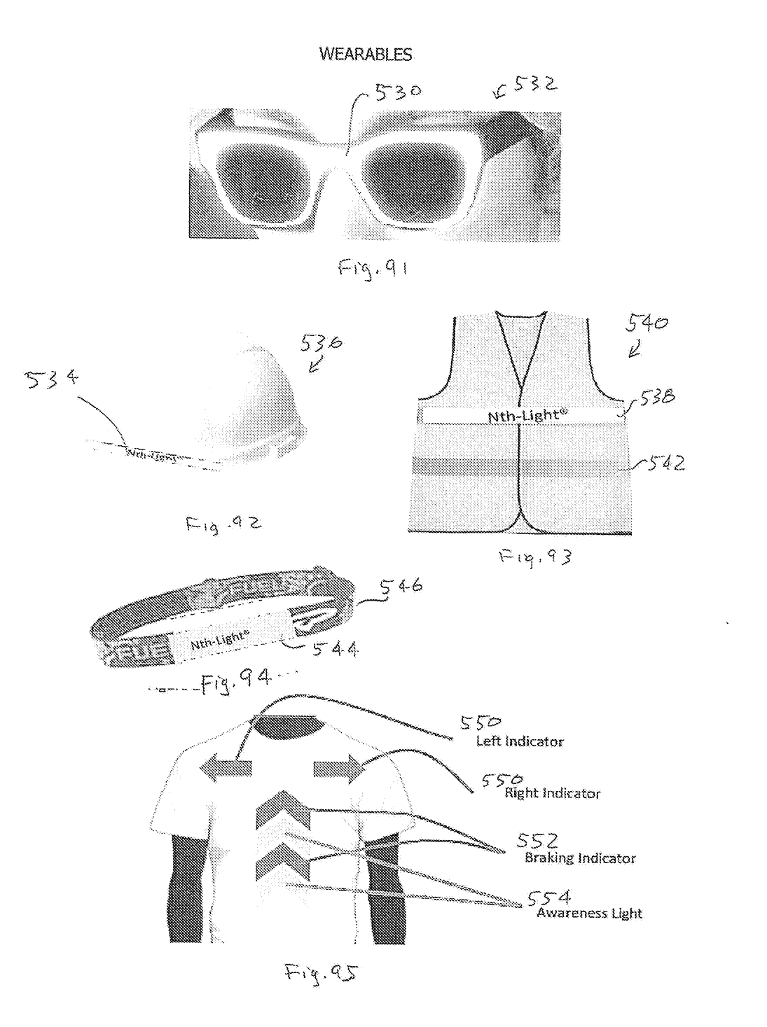

FIG. 91 illustrates how a light sheet 530 may be formed to provide a light source on the frames 532 of protective glasses, prescription glasses, sunglasses, etc. The light may be used for illuminating workpieces or the path ahead of the wearer.

FIG. 92 illustrates how the light sheet 534 may be used as a headlamp on a hardhat 536 or on any other hat for illumination or safety.

FIG. 93 illustrates how the light sheet 538 may be affixed to a vest 540 for illumination or safety. The vest may also include reflectors 542.

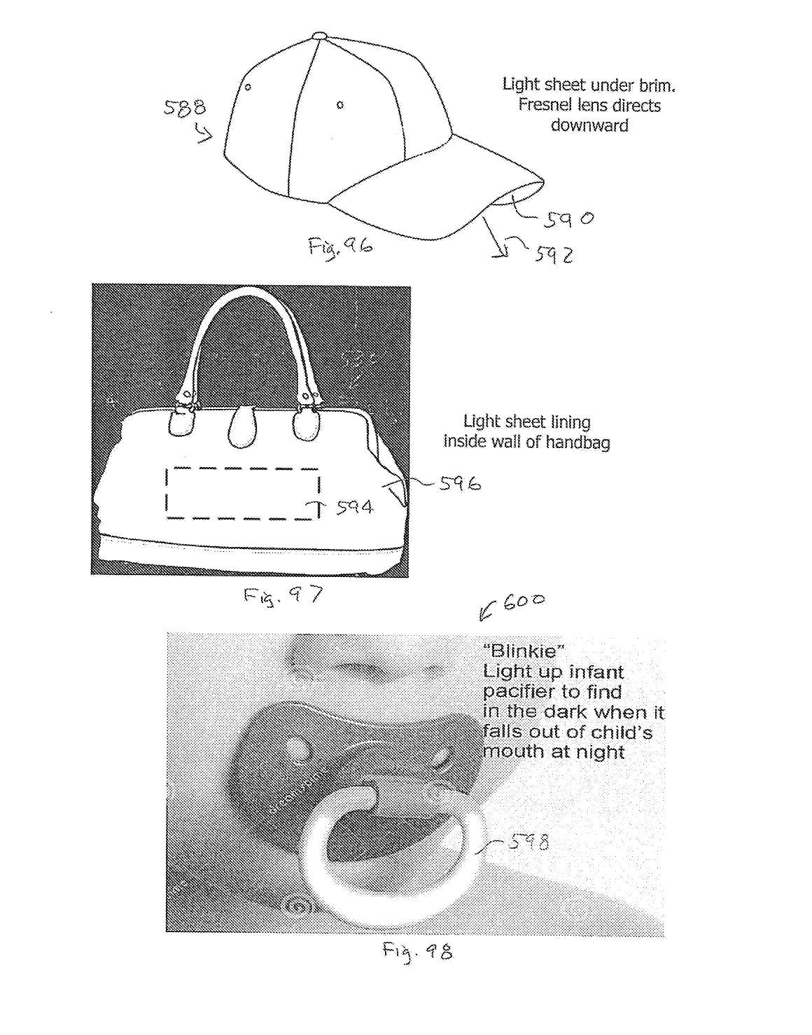

FIG. 94 illustrates how the light sheet 544 may be used on a resilient headband 546 or wristband for illumination or safety.

FIG. 95 illustrates how the light sheet may be used on a shirt 548 or vest to provide directional signals while riding a bicycle. Left and right amber indicators 550 are shown along with a red braking indicator 552 and an awareness light 554. Any type of control can be used, such as manual controls or automatic controls based on the wearer's movements.

FIG. 96 illustrates a cap 588 with the light sheet 590 located under the brim for providing down light for illumination. A Fresnel lens may be use to direct light away from the user's face. Light rays 592 are shown.

FIG. 97 illustrates how the light sheet 594 may be used along an inside wall of a handbag 596 to illuminate the contents. The light sheet 594 is automatically is energized when the handbag 596 is opened, such as by using a photocell or a switch.

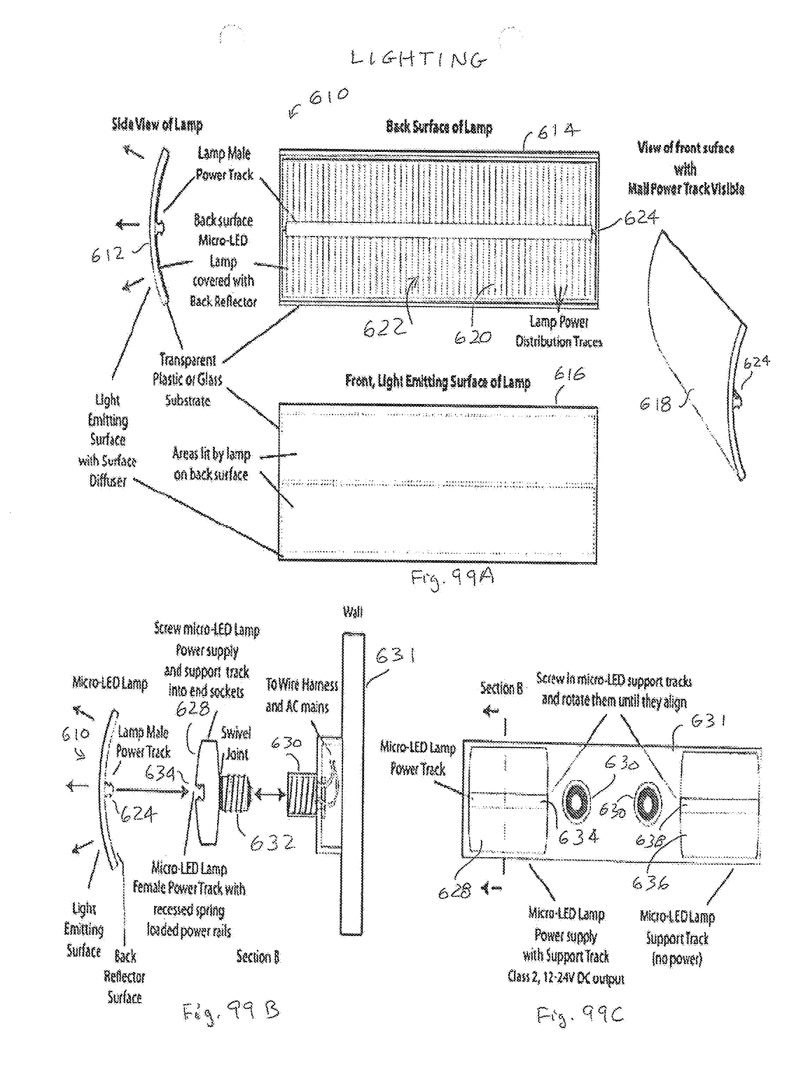

FIG. 98 illustrates how a light strip 598 within a translucent portion of a pacifier 600 allows the pacifier 60 to be easily found if dropped. The light strip 598 may only be energized when there is an impact and can be reset by touching a sensor.

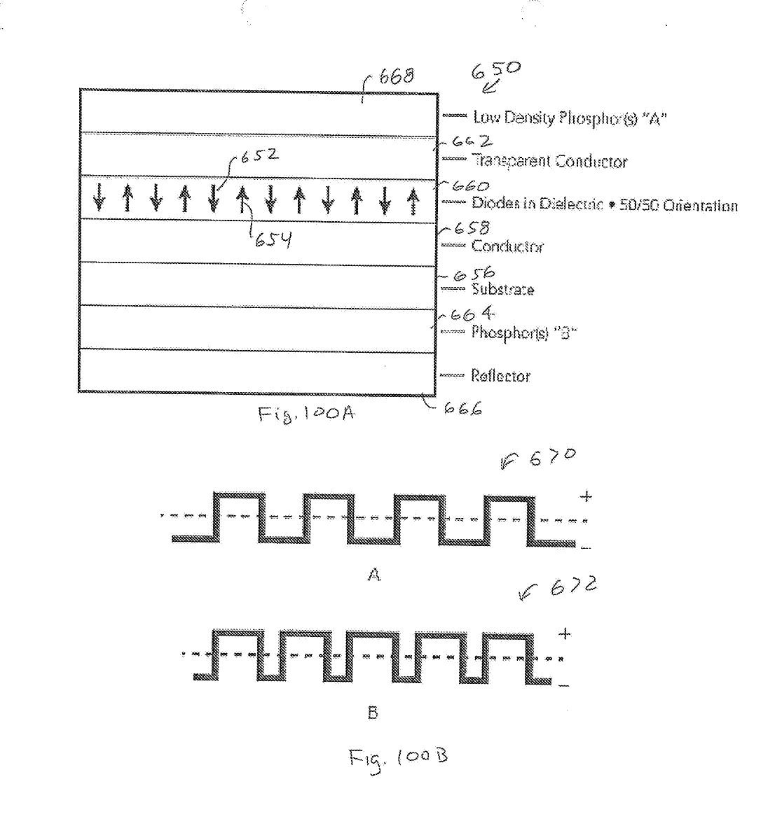

Many interesting opportunities to retrofit existing lighting fixtures with advanced LED lamps are made possible by the above-described flexible light sheets constructed using the printed micro-LED lamps. In conventional lamps, a bulb backlights a translucent decorative structure, such as a shaped glass or textile diffuser. Rather than replacing incandescent bulbs with LED bulbs having generally the same shape as the incandescent bulb, the light sheet may simply replace the outer glass or textile diffuser, obviating the need for bulbs to backlit it. An example of a vanity lamp 610 can be seen in FIG. 99A. FIG. 99A illustrates various views of a retrofit lamp 610 that may replace a conventional decorative, light diffuser backlit with incandescent, Edison type bulbs, such as for over a vanity mirror or along the sides of the vanity mirror.

The vanity lamp 610 may replace a conventional 4-bulb fixture, where the conventional fixture has a curved frosted or lenticular glass decorative attachment that is backlit by four incandescent bulbs.

A side view of the inventive lamp is shown as 612; a back view is shown as 614, a front view is shown as 616, and a front perspective view is shown as 618. The back surface of the lamp shows narrow, vertical metal distribution traces 620 that contact a backside conductor layer for supplying current to either the anodes or cathodes of the LEDs in the curved light sheet 622. There are opposing or offset metal distribution traces on the opposite side of the light sheet 622 contacting a transparent conductor layer. The metal traces distribute current over the surface of the conductor layers and have a much smaller resistance than the thin conductor layers. Along the middle of the light sheet 622 is a horizontal power track 624 having top and bottom conductors that respectively contact the frontside and backside metal distribution traces. In one embodiment, a reflective metal layer forms the backside conductor, so metal distribution traces may not be needed for the backside conductor.

The metal traces and power track 624 are not visible from the front 616 of the lamp.

Either red, green, and blue LED light sheets may be stacked to form white light having a controllable color temperature (by controlling the current to each light sheet), or a YAG phosphor may be deposited over a light sheet containing only blue LEDs to create white light.

The light sheet may be made semi-rigid by a curved plastic frame.

FIG. 99B is an exploded side view of the power source 628 for the vanity lamp 610, and FIG. 99C is a front view of two of the power sources 628 that have been screwed into the Edison-type sockets 630 of the conventional base portion 631 of the fixture. The base portion 631 may be affixed to a wall.

The power source 628 contains an AC-DC converter to convert the 120 VAC mains voltage to the DC voltage required by the lamp 610, such as 4-50 VDC (only Class 2 electrical guidelines must be met). The LEDs may be connected in any combination of series and parallel to drop the desired voltage. The power source 628 has an Edison-type screw-in connector 632 and has a front female connector 634 that electrically contacts the top and bottom metal conductors running along the power track 624. The screw-in connector 632 has some slippage relative to the remainder of the power source 628 so the screw-in connector 632 may be screwed in tight while the angle of the female connector 634 can be horizontal. The slippage may be accomplished by a joint that only engages when the power source 628 is being pushed in.

FIG. 99C shows a single power source 628 in its proper position along with a non-powered dummy source 636 that is just used for mechanical support of the lamp 610. The dummy source 636 has a non-powered female connector 638.

FIG. 99B shows how the power track 624 of the lamp 610 is slid into or pushed into the female connectors 634 and 638, where the female connector 634 provides the DC power to the lamp 610. The metal conductors in the female connector 634 may be spring loaded or resilient. The two extra sockets 630 in the conventional base portion 631 of the fixture are not needed.

If a yellow YAG phosphor coating on the light sheet is aesthetically objectionable in the off-state, a frosted diffuser may be laminated over the light sheet that creates a white appearance when it is not backlit by the lamp 610.

In another example, the lamp 610 may be much shorter and be a retrofit for a single bulb in any application. In such a case, the lamp 610 may be permanently connected to the power source. The lamp 610 may have curved sides to emit light in a hemispherical pattern or a wider pattern. Heat generation is not an issue (as it is for standard LED bulbs) since the heat generation is over a wide surface.

As another example, the tulip glass lenses used in many ceiling fans lights may be replaced with tulip lenses integrated with the micro-LED light sheets and a power supply that screws into the existing socket. The light sheets can be molded into any shape.

The lamp assembly can be of quite low mass as the lamp may be made entirely of very light plastic materials.

FIG. 100A illustrates a color-tunable lamp 650 formed of a light sheet. A user may desire to shift the color emission of a lamp for a particular mood or for a particular time of day. For example, the user may want to have a warmer (more red) light emission at night and a cooler emission (more blue) during the day. This is easy to do when there are separately controllable light sources that can emit red, green, and blue light. However, such multi-color systems are relatively complex and large, and the light mixing creates a challenge. The color-tunable lamp 650 of FIG. 100A is a flexible, ultra-thin light sheet whose light can be color-shifted using only a single power source supplying a controllable square wave current.

The LEDs 652/654 are printed with either a random orientation or an intentional 50% up/50% down orientation, and the LEDs with the different orientations are generally uniformly mixed. The arrows in FIG. 100A represent both the LEDs and the direction of light emitted by the LEDs. If the LEDs settle on the bottom conductor layer surface with a random orientation, the resulting orientations will be approximately 50% up/50% down. This random orientation may be accomplished by making the LEDs vertically symmetrical. If the orientation is to be controlled, the intended top of the LED can have an elongated electrode or the bottom electrode can be made relatively heavy. Other ways of controlling the orientations can be used. The LED are much wider than thick, so they will typically settle up or down on the bottom conductor layer. The printing process may be as previously described.

Generally, a transparent substrate 656 is supplied on a roll as a thin film (e.g., PET-a polyester). A transparent bottom conductor layer 658 (e.g., ITO or sintered silver nanowires) is provided over the substrate 656. The LEDs 652 and 654 are printed so that their bottom electrodes electrically contact the conductor layer 658. Any percentage of the LEDs can selected to have their anodes up and the remainder will have their anodes down. A 50/50 orientation is used in the example.

A dielectric layer 660 is deposited, followed by another transparent conductor layer 662 to connect the LEDs 652/654 in parallel. It is assumed all the LEDs 652/654 emit blue light.

The bottom side of the substrate 656 is coated with a first type of phosphor 664 whose emission, when combined with the LED's blue light, produces a cool white light (more blue). The phosphor 664 may be patterned (rather than be a uniform layer) so that a precise desired percentage of the blue light energizes the phosphor 664. The phosphor 664 may be YAG or another phosphor (or phosphors) that contain red and green wavelengths. Stokes-shifting materials other than phosphor may be used, such as quantum dots or a fluorescing layer.

A reflective layer 666 is then deposited on the bottom side of the phosphor 664. The reflective layer 666 may be a diffusing white layer or a specular layer, such as a reflective metal.

A different phosphor 668 is then deposited over the top transparent conductor layer 662, where the combination of the blue LED light and the phosphor 668 emission produces a warmer (redder) white light. The phosphor 668 may be patterned to have openings to allow any amount of the LED light and any amount of the phosphor 664 light to pass without wavelength conversion.

Due to inherent light absorption, less of the light emitted by the downward facing LEDs 652 will exit the top surface of the light sheet, so this has to be taken into account when driving the LEDs 652/654. Further, a percentage of the light emitted by the upward facing LED 654 will be emitted downward, and a percentage of the light emitted by the downward facing LED 652 will be emitted upward. In an example, 70% of the light emitted by an LED is assumed to be emitted in the direction of the orientation, and 30% is emitted in the opposite direction. This also has to be taken into account when driving the LEDs.

By driving the conductor layers 662/658 with an AC square wave voltage differential, some of the LEDs will be driven with one polarity and the remainder will be driven with the opposite polarity. Therefore, the relative perceived brightnesses of the up and down LED emissions is controllable by setting the relative times that the square wave polarity is positive vs. negative. This allows the warm light and the cool light to be mixed in any proportion. The frequency of the square wave should be above 60 Hz to avoid perceptible flicker.

FIG. 100B illustrates two examples of a driving square wave. In the top square wave 672, each LED orientation is driven equally. In the bottom square wave 672, the downward facing LEDs 652 are driven about half the time of the upward facing LEDs, resulting in a much warmer (redder) overall emission from the lamp 650.

In another embodiment, the reflector layer 666 may be omitted, resulting in a bidirectional lamp that can be controlled to emit different colors from both sides.

In another embodiment, two different layers of LEDs can be printed with an intermediate conductor layer between them, where the LEDs in a single layer have the same orientation but the LEDs in the two layers having opposite orientations. The intermediate conductor layer may be connected to ground, and the upper and lower conductor layers can be independently driven to selectively energize the upper and lower layers of LEDs. One or two power supplies can be used.

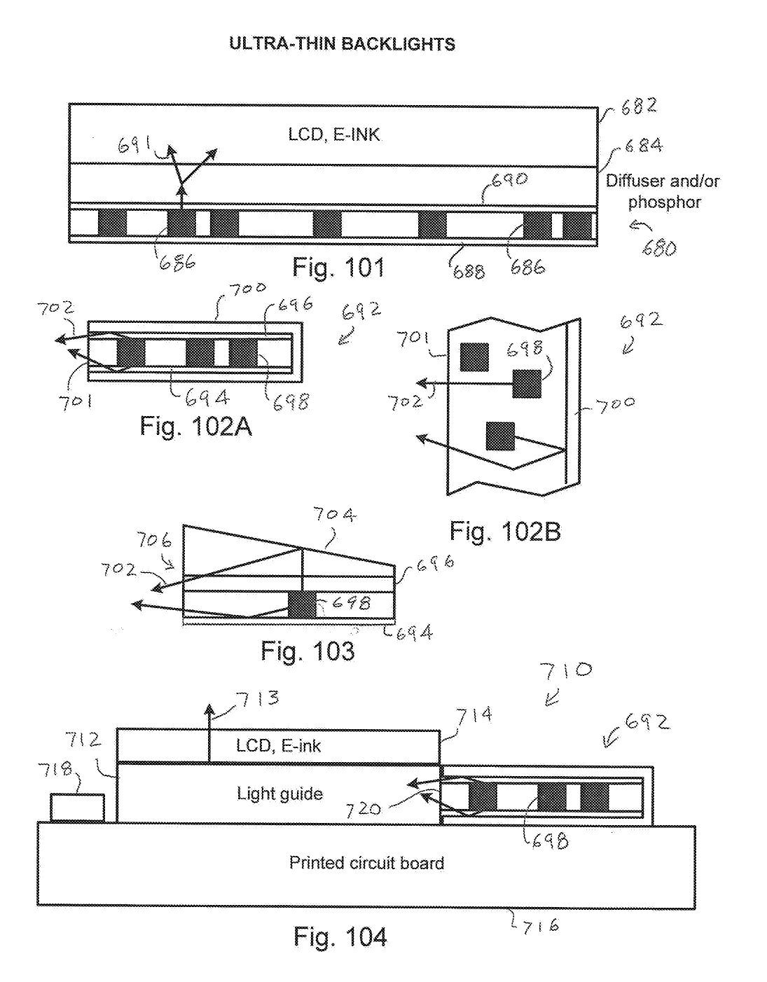

FIG. 101 is a cross-sectional view of an LED light sheet 680 backlighting a controllable display layer 682 with a diffuser film 684 therebetween to form an ultra-thin display. The diffuser film 684 may be a phosphor layer (which inherently diffuses light) and/or an optical film, such as a translucent film with a roughed surface or a prism surface. The LED dies 686 are printed on a reflective metal film 688, or on a transparent conductive film which covers a reflective substrate, such as a metal film. The locations of the LED dies 686 are random due to the printing process using LED ink. The top conductive layer 690 is transparent. The display layer 682 may be an LCD layer, an electronic ink (E-ink) layer, or other display layer. Light rays 691 are shown being emitted from an LED die 686 and diffused by the diffuser film 684, such as by being wavelength-converted by a phosphor particle. Since the LED light sheet 680 has a thickness about that of a sheet of paper, the display is ultra-thin.

FIG. 102A is a cross-sectional view of an LED light sheet 692 (formed as a narrow strip), similar to that shown in FIG. 20, where all light is emitted from a thin edge of the light sheet 692. The conductive layers 694 and 696 sandwiching the printed LED dies 698 may be a reflective metal film, or the conductive layers 694 and 696 may be transparent and a reflective layer 700 is formed around all sides except the light-exit edge 701. Light rays 702 emitted from the edge are shown. The light from the LED dies 698 is mixed within the light sheet 692. The light-exit edge 701 may be roughed to reduce TIR and to further diffuse the light. The light exiting the edge will be substantially uniform due to the random distribution of the LED dies 698 in the light sheet 692. The edge-emitting light sheet 692 can be used for any purpose, and one example will be to form an edge lit, ultra-thin backlight shown FIG. 104. The edge 701 may be coated with a phosphor to wavelength-convert and diffuse the light.

Since the LED dies 698 are microscopic, a large percentage of the light exits the side walls of the LED dies 698. This side emission may directly exit the edge 701 of the light sheet 692 without being reflected by the reflective layer 700 sandwiching the LED dies 698, improving the efficiency of the light sheet 692. The LED dies 698 may be made thicker to increase the side emission.

FIG. 102B is a top down view of a small portion of the light sheet 692 of FIG. 102A, with the top reflector layer invisible, showing light rays 702 emitted from the edge 701. The brightness may be adjusted by the density of LED dies 698 or the size of the light sheet 692.

FIG. 103 is a cross-sectional view of an edge-emitting light sheet, similar to that of FIG. 102 but having reflective optics 704 that direct light toward the light-emitting edge 706 of the light sheet. An angled reflector may be used, or other types of optics can be used, to reduce the number of internal reflections before light exits from the edge 706.

FIG. 104 is a cross-sectional view of an ultra-thin display 710, where light from the edge of the light sheet 692 of FIG. 102 is coupled into the edge of a leaky light guide 712 for backlighting a controllable display layer 714. The light guide 712 may a thin transparent film with a roughened top surface for uniformly leaking out the light 713 into the display layer 714, such as a controllable LCD layer or E-ink layer. The bottom surface and side surfaces of the light guide 712 may be coated with a reflective material. The light guide 712 and light sheet 692 are supported on a thin printed circuit board 716 that may also support any type of circuitry 718.

For any wavelength conversion, the light-emitting edge of the light sheet 692 may be coated with a phosphor 720, such as a YAG phosphor for producing white light with blue LED dies.

A very narrow light sheet 692, such as 5 mm, is desirable to minimize internal absorption of light. All edges of the light guide 712 may be contacted by a light sheet 692 for increased brightness and uniformity.

The above-described applications of the basic light sheet structure of FIG. 1 are just some of the possible applications.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. An illuminating device comprising:
a printed light emitting diode (LED) light sheet comprising a plurality of inorganic LED dies sandwiched between two conductive layers, the light sheet having at least one light emitting surface; and
a display layer backlit by the printed light sheet.

2. The device of claim 1 wherein the light sheet emits light through a first surface substantially parallel to the conductive layers, and wherein the first surface opposes the display layer.

3. The device of claim 2 further comprising a wavelength-conversion layer between the light sheet and the display layer.

4. The device of claim 1 wherein the light sheet emits light through a first edge surface, the device further comprising a light guide, the light guide having a second edge surface coupled to receive light from the first edge surface of the light sheet, wherein light exits the light guide through a non-edge surface opposing the display layer.

5. The device of claim 4 further comprising a wavelength conversion layer over the first edge.

6. The device of claim 4 wherein the light sheet has reflective surfaces that cause the light emission of the light sheet to be from the first edge surface.

7. The device of claim 6 wherein at least one of the reflective surfaces reflect light in the direction of the first edge surface.

8. The device of claim 4 wherein the first edge surface is a diffusing surface.

9. The device of claim 4 wherein the light sheet and light guide are supported by a printed circuit board surface.

10. The device of claim 1 wherein the display layer is a liquid crystal display (LCD) layer.

11. The device of claim 1 wherein the display layer is an electronic ink layer.

12. The device of claim 1 wherein there is a random distribution of LED dies in the light sheet.

13. An illuminating device comprising:
a flexible printed light emitting diode (LED) light sheet comprising a plurality of inorganic LEDs sandwiched between two conductive layers, the light sheet having at least one light emitting surface; and
an optical fiber, wherein the light sheet is optically coupled to the optical fiber.

14. The device of claim 13 wherein one end of the optical fiber is coupled to a camera and another end of the optical fiber receives an image illuminated by the light sheet.

15. The device of claim 14 wherein the light sheet emits light through a first edge surface to illuminate objects detected by the camera.
